(19) United States
(12) Patent Application Publication
(10) Pub. No.: US 2025/0285285 A1
(43) Pub. Date: Sep. 11, 2025

(54) FILTERS FOR ENHANCED IMAGE GRADIENT COMPUTATION AND EDGE DETECTION

(71) Applicant: UNIVERSITY OF SOUTH CAROLINA, COLUMBIA, SC (US)

(72) Inventors: YI WANG, CHAPIN, SC (US); LUKE BAGAN, COLUMBIA, SC (US)

(21) Appl. No.: 18/956,461

(22) Filed: Nov. 22, 2024

Related U.S. Application Data
(60) Provisional application No. 63/563,525, filed on Mar. 11, 2024.
(60) Provisional application No. 63/712,589, filed on Oct. 28, 2024.

(51) Int. Cl. G06T 7/12; G06T 5/20; G06T 5/73; G06T 7/73

(52) U.S. Cl. CPC G06T 7/12; G06T 5/20; G06T 5/73; G06T 7/73; G06T 2207/20076

(57) ABSTRACT

The disclosure deals with system and method for image gradient and derivative computation image processing. Noise, image sharpness, orientation, empirical parameters, and computational complexity are examples of image gradient and derivative computation challenges. Many traditional kernel-based operators excel at tackling one of these problems, but trade off their ability to handle others. Two new gradient detection kernels based on two-dimensional high order Taylor Series expansion tackle many such problems. The first kernel uses a wide range of the pixels in view to suppress noise, thereby improving the gradient intensities of edges. The second kernel builds on the first to leverage its noise suppression benefits while tackling an additional problem of degraded and low contrast edge boundaries. It can detect smooth lines in the presence of discontinuities and poor quality. The filter architecture allows for precise gradient calculation, edge detection, and orientation determination to less than one degree of the true value even when faced with signal to noise ratios that exceed 0.75.

### PRIORITY CLAIM

The present application claims the benefit of priority of U.S. Provisional Patent Application No. 63/563,525, filed Mar. 11, 2024, titled Novel Filters For Image Gradient Computation And Edge Detection, and the benefit of priority of U.S. Provisional Patent Application No. 63/712,589, filed Oct. 28, 2024, titled Filters For Enhanced Image Gradient Computation And Edge Detection, and both of which are fully incorporated herein by reference for all purposes.

### STATEMENT REGARDING FEDERALLY SPONSORED RESEARCH OR DEVELOPMENT

This invention was made with government support under Grant No. N00014-22-C-1011, awarded by the Office of Naval Research. The government has certain rights in the invention.

### BACKGROUND OF THE PRESENTLY DISCLOSED SUBJECT MATTER

### 1.0 Introduction

### 1.1 Image Processing

With the rise of automation and artificial intelligence, both computer vision and image processing have become the center of debate on the best and most effective way to tackle the many challenges in the industry. Image processing is the process of taking an image and applying mathematical or computational algorithms to it to extract important features and useful information or alter the original image in a favorable way. Image processing is a broad term that covers a wide set of powerful topics, some of which include image restoration, image segmentation, image compression, image morphology, object recognition, and notably for the present research topic, gradient based edge detection (A. B. da Silva & Gelson 2005). These processes are applicable to a wide variety of industries including medical imaging, autonomous vehicles, manufacturing, astronomy, professional photography, and general computer vision (Jahne 2002).

Recently, the autonomous vehicles industry has been taken over by artificial intelligence and machine learning to detect objects in images as they have displayed a high degree of accuracy with a relatively low degree of necessary computational power. While this favors machine learning in the autonomous vehicle industry and many other fields, image processing based on low-level features is progressing to mitigate computational burden on fieldable systems when it comes to objects detection and ensure its reliability. Machine learning on the other hand has not been able to improve upon its initial successes for some time and has somewhat stagnated in the field due to a variety of challenges and obstacles (Gupta et al., 2010). Machine learning requires a vast amount of training data in order to train neural networks that work reliably. This presents an inherent problem to machine learning as its performance is restricted to a dataset, and it cannot interpret unfamiliar situations which it was not specifically trained on (Guo et al., 2016). This issue becomes even exacerbated for object detection in the littoral environment being pursued by this research, because the dataset dedicated to littorals is extremely scarce, and the environment is highly cluttered and diversified.

Deep learning is meant to simulate the human vision system when it comes to autonomous vehicles, however it cannot replicate certain intangible human characteristics such as common sense, intuition, explanation, and ability to process foreign situations. This results in a set of instances which deep learning cannot address. These are often referred to as edge cases. On the other hand, image processing does not have this issue. Image processing manipulates the image at face value and defines the features known to be effective. Image processing techniques can ensure that the original image will be analyzed according to its physical representation and that nothing will be missed. Because of this, it can be argued that the autonomous vehicles industry should divert their efforts to an image processing-based pipeline that leverages image characteristics such as edges in order to detect objects.

### 1.2 Gradient Calculation and Edge Detection

Gradient detection is often used as the foundation of edge detection. This is because it addresses the physical nature of an edge in an image. Edges are defined as a rapid change in pixel intensity and can therefore be located where significant gradients exist in an image (Bhardwaj, S., & Mittal, A. 2012). Once image gradients are calculated from an image, they can be thresholded to produce binary edge maps that contain only the largest magnitude derivatives.

Widely used gradient detection filters aim to address a variety of obstacles. In doing so, they also come with their own distinct disadvantages. The most common gradient-based edge detection methods use Sobel, Prewitt, and Roberts kernels which are typically 3×3 patterns convolved around an image to produce the intensity derivatives of each pixel (Kekre & Saylee 2010). Occasionally, alternate larger variations of these kernels in 5×5, 7×7, and further increasing size are used to improve gradient and edge detection performance. In theory, the large kernels suppress noise better than the 3×3 and can effectively improve the edge map result (Bogdan, Bonchis, & Orhei 2019). However, while easy to apply to an image, the accuracy of these methods depends greatly on the image quality and presence of edges. In addition, the constant and simplistic structure of these kernels limits the performance they can achieve.

The most common issue is the presence of noise in image signals. Most gradient detection methods and edge detection methods are highly susceptible to noise and often amplify undesirable image noise due to the image sharpening properties they possess (and the small range of view used in the filter) (Lin, W., & Wang, J. 2017) (N. Ofir, M. Galun, B. Nadler & R. Basri 2016). Image smoothing filters are common to reduce the effects of noise, however such filters decrease image quality, blur edges and can make low gradient edges undetectable. On top of this, they alter the real intensity of information provided from the original image.

Additional external factors like refraction, poor focus, object obstruction, low light, smooth intensity transitions and others can all affect the quality of an edge boundary. Considering all these influences, traditional edge detectors commonly result in false detection, missed detection, and inaccurate localization. Alternative methods to gradient-based edge detection that delve into second derivative zero crossings, deep learning based approaches, image morphology, and more have been proposed to address these issues (Sun et al., 2022). A systematic approach that can directly operate on the original images and raw pixel intensities and address most of the issues with minimal manual manipulation is still strongly needed.

### 1.3 Angle Detection

In gradient-based edge detectors, gradients are only part of the equation when it comes to determining if a pixel is an edge or not. Edge orientation information is typically a critical piece of data to use with gradient magnitudes to make an accurate determination as to whether an edge exists in a specific location. For example, when many edges align with a specific direction in the littoral environment, they may represent the wave crest. Gradient operators will produce a wide variety of derivative magnitudes across an image with thick gradient lines around edges in a photo. This poses a problem of edge pixel localization which can be addressed with extreme precision when using highly accurate gradient angles for corresponding pixels. Edges will always produce the largest derivatives in a local cluster of gradients, and knowing their angles means the maximum gradient and therefore edge location can be extracted from the immediate neighborhood by tracing along the orthogonal direction. Outside of the information it can provide to improve edge pixel accuracy, gradient orientations can be used for effective image segmentation and even improve image set rectification (Cheng & Chai 2019) (Donoser & Schmalsteig 2014). Effective gradient estimation proves to be a very useful area of image processing requiring innovation.

Conventional methods for determining angles are insufficient in terms of accuracy. The most accepted method, which is used in Canny's edge detection process, for obtaining a pixel's gradient direction is to use the arctangent of the x and y gradients (Bhardwaj, S., & Mittal, A. 2012). This method is unacceptable as it relies on accurate gradient information in two directions, assuming no errors will be produced in those directions to skew the calculation. For example, if an edge lies at a 45 degree angle, its angle will be estimated using the distant gradients obtained in the x and y direction. Any errors in the x and y direction will be translated into the angle calculation. This results in vague estimations of angles which are never true to the actual values. The errors in this method are visible when it comes to determining edges with them and explain why Canny suffers from broken edges and false positives.

Edge determination is a challenging yet crucial step in the object detection process for images. It is the first in a multi-step process, serving as the foundation for all subsequent operations. Its accuracy directly affects the success of any future processing techniques and final detection. The challenge of edge detection is derived from a variety of factors, including noise, image sharpness, orientation, empirical parameters, and computational complexity. Many traditional kernel-based operators excel at tackling one of these problems, but trade off their ability to handle others. For example, the popular Sobel operator uses a horizontal and vertical constant high-pass kernel. The two kernels are used to tackle other operators' challenges of directional propensity. Theoretically, the combined two kernels can estimate edge orientations with a certain degree of accuracy; however, the effectiveness of its two directional operators are not justified. This means it uses an arbitrary combination of the two kernels. Additionally, its high-pass nature amplifies noise, and the constant architecture of its kernel means it is unable to adapt to the varying light intensities in the photo. This presents large issues in localizing edges and accurately identifying them in the first place.

### SUMMARY OF THE PRESENTLY DISCLOSED SUBJECT MATTER

The presently disclosed subject matter relates to gradients while generally relating to sensor technology and high order derivatives. In some instances, the presently disclosed subject matter relates further to edge detection, object detection, image segmentation, image processing, computer vision, low-level features, manufacturing, medical imaging, image correction, image enhancement, quality control, localization, gradient orientation, and angle detection features or subject matter.

The disclosure more particularly deals with system and method for derivative/gradient calculation in object detection image processing. Noise, image sharpness, orientation, empirical parameters, and computational complexity are example derivative/gradient calculation challenges. Many traditional kernel-based operators excel at tackling one of these problems, but trade off their ability to handle others. Two new gradient detection kernels based on two-dimensional high order Taylor Series expansion tackle many such problems. The first kernel uses a wide range of the pixels in view to suppress noise, thereby improving the gradient intensities of edges. The second kernel builds on the first to leverage its noise suppression benefits while tackling an additional problem of degraded and low contrast edge boundaries. It can detect smooth lines in the presence of discontinuities and poor quality. The filter architecture allows for precise gradient calculation, edge detection, and orientation determination to less than one degree of the true value even when faced with signal to noise ratios that exceed 0.75.

Conventional methods for determining angles are insufficient in terms of accuracy. A better method would search for edges with a finer angular resolution to produce a set of gradients where one dominant gradient at a specific orientation prevails above the rest.

In addition to allowing us to localize edges with high fidelity, gradient angles serve as a low-level image feature that can provide many benefits in a variety of image processing techniques. Pixel orientation can provide insight into objects in the photo and characterize their immediate movement. In addition, it can be used as a piece of data to group similar edges in the photo together. One straightforward and practical use for angles is to group wave edges together from an aquatic scene so that the water can be analyzed. Another way angles can be useful is to separate edges in a scene that may have been incorrectly linked during the edge determination process. Using highly accurate angles in low level features improves the accuracy of all the associated processes.

### 1.4 Research Objective

The most popular autonomous driving systems on the market today, like Tesla's autopilot, are built with AI and deep learning at the core. These models have proven time and again to be unreliable and dangerous for a multitude of reasons. The main problem facing this industry is the need for vast amounts of training data required to train neural networks which are intended to replicate human visual and decision-making systems. The truth is, however, there will never be enough training data to address all the edge cases that an AI-powered autonomous navigation system may encounter. Physics and image processing-based methods will be necessary to ensure that edge cases will not pose an issue to these systems and to reach level five full driving automation.

The objective of this research is to build upon the foundational concepts necessary for a physics-based autonomous driving suite. This includes developing all the necessary components for a highly reliable edge detection process, which can be taken in the future and used as the basis for an object detection pipeline. The components can be boiled down to three principal ideas. The first is a highly accurate gradient calculation kernel, which is robust to low signal-to-noise ratio environments, can bridge small breaks/occlusions in the image, and can recognize gradients produced from exceedingly small objects. In addition, a similar kernel will be necessary which is more capable in detecting line edges rather than point edges. Both kernels should be adaptable to address a wide variety of image scenarios. The final necessary component would be a gradient orientation detection system, which can determine the angle of an edge within one degree of its true value. Section 2 covers the development of the wide view filter, which is a derivative calculation kernel built using the ideas of the two-dimensional Taylor Series expansion and serves to address the issues of low SNR environments and small object recognition. Section 3 discusses the development of the line filter, which is based on the wide view filter and excels in the line detection and small occlusion bridging. Section 4 compares the results using these filters with conventional edge detection methods like Canny and Sobel. Finally, Section 5 outlines a novel angle detection process, which can meet the strict accuracy limitations set in place.

The presently disclosed combination of wide view and line filter components are image gradient/derivative computation and filters capable of producing the information necessary to determine if an edge exists in a photo and its orientation with previously unachievable accuracy. This is because it solves issues that traditional edge detection methods have not been able to circumvent such as image signal noise, arbitrary edge orientation, edge discontinuity/obstruction, image sharpness, and low contrast boundaries. The disclosed filters can accurately produce smooth connected gradient values suitable for edge determination better than any traditional gradient-based operator on the market. When combined with the novel angle detection method, these filters are also capable of calculating gradient orientations within one degree of their true value. The preferable gradients produced by the Wide View and Line Filter can be extended to many subsequent image processing techniques which rely on image gradients and derivatives.

The presently disclosed combination of wide view and line filters will be used for accurate image gradient computation and edge detection in a variety of industries, but most prominently for autonomous vehicles where accurate low-level features like edges can greatly enhance object detection. They can also be used in medical image processing where image quality is a prominent issue in the industry. Image enhancement/correction, and consumer photography pipelines that aim to produce high quality images using various techniques requiring edges will benefit from the gradient localization and prominence that the wide view and line filters can produce. Any image processing pipelines that require accurate gradients will benefit from the use of the wide view and line filters. The new angle detection methods combined with the wide view and line filters can also greatly enhance gradient orientation accuracy that can be used another feature in image processing to improve low level feature extraction, object detection, and image segmentation.

Representative exemplary products which could benefit from incorporation of presently disclosed subject matter include such as Canny edge detection, EDTER: edge detection with transformer, BDCN edge detection, auto pilots, autonomous driving, self-driving cars, image processing and computer vision libraries, and consumer photography systems hardware/software. Exemplary products which could be replaced with the incorporation of presently disclosed subject matter include, the Sobel gradient operator, Prewitt gradient operator, derivative of Gaussian operator, Laplacian of Gaussian operator, and any gradient or derivative based image processing techniques.

The anticipated potential market size for the presently disclosed technology is relatively large. For example, such market could involve Autonomous Vehicles ˜122 billion USD 2022 (Worldwide), Smartphone Image Processing ˜500 billion USD 2022 1.2 billion units/year (Worldwide), Medical Imaging Analysis ˜1 billion USD 2022 (US) 3 billion USD 2022 (Worldwide), Image Recognition ˜38 billion USD (2022), and Image Processing (Incl. Automated Manufacturing Quality Processing) ˜34.75 billion USD (2022).

Some aspects of the presently disclosed technology possibly providing competitive advantages are that the wide view and line filter greatly increase the accuracy of traditional edge detection methods. They can produce much more consistent, high quality, smooth, and connected gradients for producing spatially correct edges even in the presence of extreme image noise and poor quality. These gradient improvements are based on a few factors leveraged by both filters. It has the ability to detect a gradients orientation within one degree of its true value. These benefits can improve the reliability of associated image processing pipelines that rely on either high-quality gradients or edges. Notably this can help push autonomous driving industries forward as they have stagnated pursuing machine learning techniques (in particular, for special environments like maritime and littorals) as well as improve medical image processing, and automated manufacturing processes.

In one exemplary embodiment disclosed herewith, a system and method for gradient and derivative determination is described.

It is to be understood that the presently disclosed subject matter equally relates to associated and/or corresponding methodologies. One exemplary such method relates to methodology for image gradient and derivative computation image processing, comprising obtaining a target digital image comprising a plurality of pixels; and applying gradient detection to the pixel data of the target digital image, wherein said gradient detection comprises use of both a wide view filter and a line filter, and combining the output of the wide view filter and the line filter to indicate edges appearing in the target digital image.

Another exemplary such method relates to methodology for image gradient and derivative computation image processing, comprising obtaining a target digital image comprising a plurality of pixels; using both a wide view filter and a line filter for respectively applying gradient detection to the pixel data of the target digital image to respectively perform derivative calculations based on pixel values; using one of the wide view filter or the line filter to calculate derivative maps of the derivative values of each pixel from the target digital image at a plurality of selected orientation angles; combining the output of the wide view filter and the line filter to indicate edges appearing in the target digital image; performing angle detection by parsing through each pixel of the derivative maps to produce numerically interpolated angle estimate and subsequently a histogram of the frequency of all the angles calculated for each pixel in the image; and clustering all the angles to match determined edges in the image.

Other example aspects of the present disclosure are directed to systems, apparatus, tangible, non-transitory computer-readable media, user interfaces, memory devices, and electronic devices for gradient and derivative determination in object detection image processing. To implement methodology and technology herewith, one or more processors may be provided, programmed to perform the steps and functions as called for by the presently disclosed subject matter, as will be understood by those of ordinary skill in the art.

Another exemplary embodiment of presently disclosed subject matter relates to a system for image gradient and derivative computation image processing, comprising a target digital image comprising a plurality of pixels; and one or more processors programmed for applying gradient detection to the pixel data of the target digital image, wherein said gradient detection comprises use of both a wide view filter and a line filter, and combining the output of the wide view filter and the line filter to indicate edges appearing in the target digital image.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 illustrates an exemplary schematic of a global and local coordinate system, and representing an example of how the presently disclosed wide view filter looks situated in an image at a pixel center (X₀, Y₀);

FIG. 2 illustrates an exemplary schematic of the local coordinate system with wide view filter layout of FIG. 1, and with a schematic of an exemplary presently disclosed line filter layout on the right-hand side of the illustration;

FIG. 3 illustrates an exemplary synthetic line photo used for initial analysis of the presently disclosed wide view and line filters;

FIG. 4 is a tabular format illustration for comparison of presently disclosed gradients and edges obtained with presently disclosed wide view and line filter subject matter, respectively, compared with results of Sobel and Prewitt kernels, all used for processing the synthetic line photo of present FIG. 3;

FIG. 5 illustrates an exemplary Canny edge map produced from the synthetic line image of present FIG. 3, using the Derivative of Gaussian method;

FIGS. 6(a) through 6(d) comprise a set of new synthetic line photos with varying SNR Levels used for SNR Analysis with the presently disclosed filter subject matter, with FIGS. 6(a) through 6(d) respectively having SNR levels of 2.0, 1.0, 0.75, and 0.5;

FIG. 7 is a tabular format illustration for comparison of presently disclosed gradients and edges obtained with a base configuration of the line filter subject matter produced from a multi-line photo, respectively, for SNR levels of 2.0, 1.0, 0.75, and 0.5;

FIG. 8 is a tabular format illustration for comparison of presently disclosed gradients and edges obtained with larger filter size subject matter produced from a multi-line photo, respectively, for SNR levels of 1.0, 0.75, and 0.5;

FIG. 9 is an exemplary highly washed-out image of a body of water (Lake Murray, South Carolina);

FIG. 10 is a tabular format illustration for comparison of presently disclosed gradients and edges obtained with presently disclosed wide view and line filter subject matter, respectively, compared with results of Sobel and Prewitt kernels, all used for processing the exemplary highly washed-out aquatic image photo of present FIG. 9;

FIGS. 11(a) and 11(b) illustrate the first stage of presently disclosed angle detection procedure, illustrating a cubic spline for one pixel contributing to the histogram containing all pixel angle values for an image, with FIG. 11(a) graphically representing a set of piecewise function continuous to the second derivative, and with FIG. 11(b) graphically representing a histogram displaying the frequency of all the angles calculated in the image;

FIGS. 12(a) through 12(d) represent steps in postprocessing flow of the presently disclosed angle detection script, including with the mean of the histogram data calculated and any bins with occurrences smaller than the mean disregarded (as graphically represented by FIG. 12(a)), then removing background pixels with random noises in the images as they do not exhibit dominant angle detections (as graphically represented by FIG. 12(b)), with the data then clustered into groups, which correspond to edges found in the image (as graphically represented by FIG. 12(c)), and lastly with any pixels within a cluster remapped onto the image to visualize their final calculated angles (as graphically represented by FIG. 12(d));

FIG. 13 illustrates an exemplary synthetic line image pertinent to presently disclosed subject matter as otherwise discussed herein;

Similar to the illustrations of FIGS. 12(a) through 12(d), respectively, FIGS. 14(a) through 14(d) represent, respectively, steps in postprocessing flow of the presently disclosed angle detection script, in the case of a subject multi-line photo (FIG. 13) with close lines angle detection results at a 10-degree angular resolution;

FIG. 15 illustrates an exemplary dense synthetic line image pertinent to presently disclosed subject matter as otherwise discussed herein;

Similar to the illustrations of FIGS. 14(a) through 14(d), respectively, FIGS. 16(a) through 16(d) represent, respectively, steps in postprocessing flow of the presently disclosed angle detection script, in the case of a subject dense multi-line photo (FIG. 15) with close lines angle detection results at a 10-degree angular resolution;

FIG. 17 is an exemplary wave field image of a body of water (Lake Murray, South Carolina);

Similar to the illustrations of FIGS. 16(a) through 16(d), respectively, FIGS. 18(a) through 18(d) represent, respectively, steps in postprocessing flow of the presently disclosed angle detection script, in the case of the exemplary aquatic wave field photo (FIG. 17) with close lines angle detection results at a 10-degree angular resolution;

FIG. 19 is a zoomed in view of the FIG. 17 image of an exemplary wave field of a body of water (Lake Murray, South Carolina);

FIG. 20 is an exemplary synthetic line image of the aquatic subject matter of Lake Murray (South Carolina); and

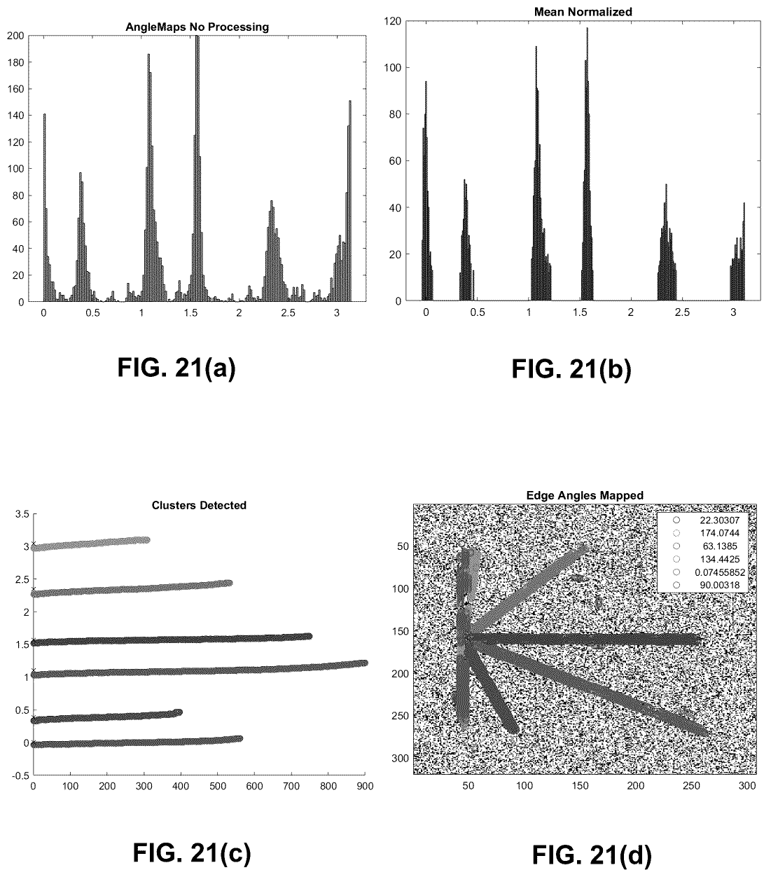

Similar to the illustrations of FIGS. 18(a) through 18(d), respectively, FIGS. 21(a) through 21(d) represent, respectively, steps in postprocessing flow of the presently disclosed angle detection script, in the case of a multi-line exemplary synthetic line image of aquatic subject matter (FIG. 20) with close lines and low SNR angle detection results at a 10-degree angular resolution (Np=150 & Filter Size=29 px).

Repeat use of reference characters in the present specification and drawings is intended to represent the same or analogous features, elements, or steps of the presently disclosed subject matter.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to a system which includes all the necessary components for a highly reliable gradient and derivative determination process, which can be taken in the future and used as the basis for an object or edge detection pipeline. The components can be boiled down to three principal ideas. The first is a highly accurate gradient calculation kernel, which is robust to low signal-to-noise ratio environments, can bridge small breaks/occlusions in the image, and can recognize gradients produced from exceedingly small objects. In addition, a similar kernel will be necessary which is more capable in detecting line edges rather than point edges. Both kernels should be adaptable to address a wide variety of image scenarios. The final necessary component would be a gradient orientation detection system, which can determine the angle of an edge within one degree of its true value. Section 2 covers the development of the wide view filter, which is a derivative calculation kernel built using the ideas of the two-dimensional Taylor Series expansion and serves to address the issues of low SNR environments and small object recognition. Section 3 discusses the development of the line filter, which is based on the wide view filter and excels in the line detection and small occlusion bridging. Section 4 compares the results using these filters with conventional edge detection methods like Canny and Sobel. Finally, Section 5 outlines a novel angle detection process, which can meet the strict accuracy limitations set in place.

### 2.0 Development of the Wide View Filter

The most critical step in building a reliable object detection system is establishing where true edges exist in an image. Doing so requires a highly robust derivative calculation kernel. The biggest issue traditional kernels face is signal noise, which interferes with the ability to obtain the true derivative value at a pixel. Typically, noise poses an extreme problem in obtaining spatial derivatives due to the form of gradient calculation kernels. Gradient kernels resemble image sharpening filters, which inherently increase the prominence of noise. The wide view filter is built to tackle this problem in this thesis research first by incorporating significantly more image information into the calculation (Alpert et al. 2010). This is consistent with the human vision system which is generally unaffected by noise in its wide view (N. Ofir, M. Galun, B. Nadler & R. Basri 2016). In addition to considering a new and larger filter framework, the wide view aims to attain industry-leading gradient accuracy by changing the method by which image derivatives are calculated and by providing a malleable architecture.

### 2.1 Wide View Filter Architecture

The wide view filter operates based on the principles of the two-dimensional Taylor Series expansion, and the mathematical foundation for calculating the high-order derivates using a least-squares approach is provided in detail in section 2.2. Before that, it is important to understand how the wide view filter is constructed and how its architecture differs from common gradient operators such as the Sobel operator.

The most common Sobel operators are three-by-three kernels centered around the indexed pixel and calculate the horizontal and vertical gradients in an image that are combined to create one gradient magnitude matrix. These are very susceptible to noise due to their constant structure and small size. The presently disclosed wide view filter, on the other hand, depends on the number of pixels, Nₚ, around an indexed pixel in the calculation. The wide view filter will automatically select the closest Nₚ pixels to the index, which generally yields a circular structure. Importantly, Nₚ will contain upwards of 100 neighboring pixels, meaning it is significantly more robust to signal noise when compared to the Sobel operator and the nine neighbors it uses.

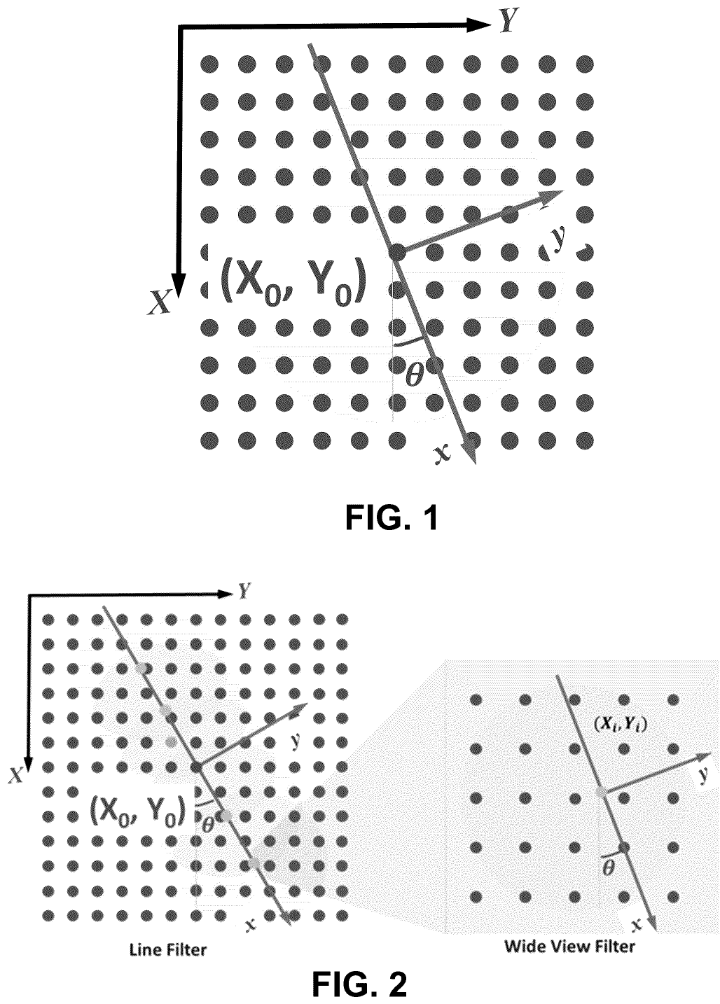

The nearest neighbors of the indexed pixel define a local coordinate system denoted as (x, y), which is contained in the global image coordinate system denoted as (X, Y) where X=1, 2, . . . , Nₕ and Y=1, 2, . . . , Nᵥ, where Nₕ and Nᵥ are, respectively, the number of pixels along the horizontal and the vertical direction. The local coordinates (x, y) are, in turn, along the tangential and the normal direction of the local coordinate system used for computing the high-order derivatives. FIG. 1 illustrates an exemplary schematic of a global and local coordinate system, and representing an example of how the presently disclosed wide view filter looks situated in an image at a pixel center (X₀, Y₀). This pixel center represents a few significant locations for the gradient calculation. It is the location where the tangential and the normal derivatives need to be computed as well as the origin of the local coordinate system. The local coordinates containing Nₚ neighbor pixels are captured in the light-yellow region. Their coordinate axes can be rotated to obtain gradients in the normal and tangential directions in many intervals, allowing for highly accurate derivative calculations at many different angular positions. The tangential direction will have an angle offset θ between 0 and 2π with respect to the horizontal direction of the image (X).

### 2.2 Wide View Filter Algorithm

The gradients for the indexed pixel (X₀, Y₀), in the global coordinate system, will be calculated using a Taylor series expansion which is given in the following equation.

$$f ( x , y ) = f ( 0 , 0 ) + {f}_{x} ( 0 , 0 ) x + {f}_{y} ( 0 , 0 ) y + \frac{{f}_{xx} ( 0 , 0 ) {x}^{2}}{2} + \frac{{f}_{yy} ( 0 , 0 ) {y}^{2}}{2} + {f}_{xy} ( 0 , 0 ) xy + \frac{{f}_{{x}^{3}} ( 0 , 0 ) {x}^{3}}{6} + \frac{{f}_{{y}^{3}} ( 0 , 0 ) {y}^{3}}{6} + \frac{{f}_{{x}^{2} y} ( 0 , 0 ) {x}^{2} y}{2} + \frac{{f}_{{xy}^{2}} ( 0 , 0 ) {xy}^{2}}{2} + \frac{{f}_{{x}^{4}} ( 0 , 0 ) {x}^{4}}{24} + \frac{{f}_{{y}^{4}} ( 0 , 0 ) {y}^{4}}{24} + \frac{{f}_{{x}^{3} y} ( 0 , 0 ) {x}^{3} y}{6} + \frac{{f}_{{xy}^{3}} ( 0 , 0 ) {xy}^{3}}{6} + \frac{{f}_{{x}^{2} {y}^{2}} ( 0 , 0 ) {x}^{2} {y}^{2}}{4} + \frac{{f}_{{x}^{5}} ( 0 , 0 ) {x}^{5}}{120} + \frac{{f}_{{y}^{5}} ( 0 , 0 ) {y}^{5}}{120} + \frac{{f}_{{x}^{4} y} ( 0 , 0 ) {x}^{4} y}{24} + \frac{{f}_{{x}^{3} {y}^{2}} ( 0 , 0 ) {x}^{3} {y}^{2}}{12} + \frac{{f}_{{x}^{2} {y}^{3}} ( 0 , 0 ) {x}^{2} {y}^{3}}{12} \qquad Eq . ( 1 )$$

In this expression, f(x, y) corresponds to the pixel intensity at any of the pixels in the local coordinate system, while x and y correspond to the offset of that respective pixel from the local origin. For the sake of concise expression derivatives typically denoted in the following convention, f_{xxyy}, are instead represented fₓ²_{y}². Assuming there are Nₚ pixels closest to (X₀, Y₀) enclosed in the yellow circular region in FIG. 1, which are denoted as (X, Y) and (Xᵢ, Yᵢ) and i=1, 2, . . . , Nₚ, then the Tayor series expansion at the origin of the local coordinate system, i.e., (X₀, Y₀) in the global coordinate, is written using the following format.

$$f ( {x}_{i} , {y}_{i} ) = {f}^{0} + {f}_{x}^{0} x + {f}_{y}^{0} y + \frac{{f}_{xx}^{0} {x}^{2}}{2} + \frac{{f}_{yy}^{0} {y}^{2}}{2} + {f}_{xy}^{0} xy + \frac{{f}_{{x}^{3}}^{0} {x}^{3}}{6} + \frac{{f}_{{y}^{3}}^{0} {y}^{3}}{6} + \frac{{f}_{{x}^{2} y}^{0} {x}^{2} y}{2} + \frac{{f}_{{xy}^{2}}^{0} {xy}^{2}}{2} + \frac{{f}_{{x}^{4}}^{0} {x}^{4}}{24} + \frac{{f}_{{y}^{4}}^{0} {y}^{4}}{24} + \frac{{f}_{{x}^{3} y}^{0} {x}^{3} y}{6} + \frac{{f}_{{xy}^{3}}^{0} {xy}^{3}}{6} + \frac{{f}_{{x}^{2} {y}^{2}}^{0} {x}^{2} {y}^{2}}{4} + \frac{{f}_{{x}^{5}}^{0} {x}^{5}}{120} + \frac{{f}_{{y}^{5}}^{0} {y}^{5}}{120} + \frac{{f}_{{x}^{4} y}^{0} {x}^{4} y}{24} + \frac{{f}_{{xy}^{4}}^{0} {xy}^{4}}{24} + \frac{{f}_{{x}^{3} {y}^{3}}^{0} {x}^{3} {y}^{3}}{12} + \frac{{f}_{{x}^{2} {y}^{3}}^{0} {x}^{2} {y}^{3}}{12} \qquad Eq . ( 2 )$$

In this case, f⁰ is the shorthand notation of f(0, 0). In Eq. (2), all terms of xᵢ and yᵢ are known since they only represent the relative positions between the neighboring pixels and the target indexed pixel. Considering all the known terms, all that is left to calculate are the intensity value f⁰ and the derivative coefficients. Although it may seem arbitrary to calculate the intensity value of the origin pixel, f⁰, since that should be known, the origin could be corrupted by noise. In a case where the origin is corrupted, it serves better to estimate the intensity, f⁰, of the origin pixel.

Another variation of the wide view filter can easily be implemented which considers the intensity value of the origin as known. This will slightly alter the Eq. (3). The origin intensity will always be multiplied by the column of ones in the A matrix which means it will always carry through as itself in the summation steps of matrix multiplication. It can therefore be removed from the z vector and subtracted from the b vector while the column of ones are removed from the A matrix if it is desired to operate the wide view filter in such a way.

Moving on from the origin, the derivative coefficients must be calculated. Specifically, when the 4th-order derivative is the highest order, there are 15 unknowns that are the coefficients of all the derivatives. If the highest-order derivative is the 5th, the number of unknowns is 21. To obtain the 15 unknowns in the former system, we need at least 15 neighboring pixels, i.e., (xᵢ, yᵢ) and i=1, 2, . . . , Nₚ and Nₚ=15, to generate a system of equations. In general, we will consider more than the minimum number of pixels necessary to minimize bias introduced by a few erroneous pixel values. In any case, this results in Nₚ equations, which can be cast into a compact matrix form represented by the following equation.

$${\underbrace{[ \begin{matrix}1 & {x}_{1} & {y}_{1} & ⋯ & \frac{1}{4} {x}_{1}^{2} {y}_{1}^{2} & \frac{1}{6} {x}_{1} {y}_{1}^{3} \\ 1 & {x}_{2} & {y}_{2} & ⋯ & \frac{1}{4} {x}_{2}^{2} {y}_{2}^{2} & \frac{1}{6} {x}_{2} {y}_{2}^{3} \\ ⋮ & ⋮ & ⋮ & ⋮ & ⋮ & ⋮ \\ 1 & {x}_{{N}_{p}} & {y}_{{N}_{p}} & ⋯ & \frac{1}{4} {x}_{{N}_{p}}^{2} {y}_{{N}_{p}}^{2} & \frac{1}{6} {x}_{{N}_{p}} {y}_{{N}_{p}}^{3}\end{matrix} ]}}_{A} {\underbrace{[ \begin{matrix}{f}^{0} \\ {f}_{x}^{0} \\ {f}_{y}^{0} \\ ⋮ \\ {f}_{{x}^{2} {y}^{2}}^{0} \\ {f}_{{xy}^{3}}^{0}\end{matrix} ]}}_{z} = {\underbrace{[ \begin{matrix}f ( {x}_{1} , {y}_{1} ) \\ f ( {x}_{2} , {y}_{2} ) \\ ⋮ \\ f ( {x}_{{N}_{p}} , {y}_{{N}_{p}} )\end{matrix} ]}}_{b} \qquad Eq . ( 3 )$$

Casting the system of equations into a matrix form allows all the derivatives to be computed in one shot using the format below.

$$Z = {( {A}^{T} A )}^{- 1} {A}^{T} b = Ab \qquad Eq . ( 4 )$$

The superscript * represents the matrix pseudo-inverse. As shown by Eq. (4), in order to apply the precomputed filter coefficients to a new image, the pseudo-inverse matrix of A, i.e., A* needs to be saved. In addition, since only the derivatives along the tangential and the normal directions are needed, i.e., the mixed derivatives in Eq. (2) are not needed, only the row entries corresponding to these desired derivatives are stored, further reducing the storage. This also means that no cross-derivatives will be considered for the indexed pixel. Only normal and tangential derivatives will be computed, which will result in two times the highest order of derivative considered in the equation being calculated for the central pixel.

After the derivatives are calculated for the wide view filter in a specific orientation, the local coordinate axis can be rotated, and the process repeated. Doing so will change the A matrix in Eq. (3) as the relative positions from the local axes will change. This can be done for any arbitrary angle with a large number of Nₚ and will result in the ability to determine a precise derivative magnitude for any edge, no matter its position or rotation in the image.

The neighboring pixels may have differential contributions to the calculation of the numerical derivatives at the origin of the local coordinate. Specifically, the pixels far away from the origin may have less important contributions, and the influences of all pixels should be weighted according to their difference from the origin. Mathematically, this is equivalent to multiplying a diagonal weight matrix on both sides of Eq. (3), i.e.,

$${\underbrace{[ \begin{matrix}\sqrt{{w}_{1}} & & & \\ & \sqrt{{w}_{2}} & & \\ & & ⋱ & \\ & & & \sqrt{{w}_{{N}_{p}}}\end{matrix} ]}}_{\sqrt{W}} {\underbrace{[ \begin{matrix}1 & {x}_{1} & {y}_{1} & ⋯ & \frac{1}{4} {x}_{1}^{2} {y}_{1}^{2} & \frac{1}{6} {x}_{1} {y}_{1}^{3} \\ 1 & {x}_{2} & {y}_{2} & ⋯ & \frac{1}{4} {x}_{2}^{2} {y}_{2}^{2} & \frac{1}{6} {x}_{2} {y}_{2}^{3} \\ ⋮ & ⋮ & ⋮ & ⋮ & ⋮ & ⋮ \\ 1 & {x}_{{N}_{p}} & {y}_{{N}_{p}} & ⋯ & \frac{1}{4} {x}_{{N}_{p}}^{2} {y}_{{N}_{p}}^{2} & \frac{1}{6} {x}_{{N}_{p}} {y}_{{N}_{p}}^{3}\end{matrix} ]}}_{A} {\underbrace{[ \begin{matrix}{f}^{0} \\ {f}_{x}^{0} \\ {f}_{y}^{0} \\ ⋮ \\ {f}_{{x}^{2} {y}^{2}}^{0} \\ {f}_{{xy}^{3}}^{0}\end{matrix} ]}}_{z} = {\underbrace{[ \begin{matrix}\sqrt{{w}_{1}} & & & \\ & \sqrt{{w}_{2}} & & \\ & & ⋱ & \\ & & & \sqrt{{w}_{{N}_{p}}}\end{matrix} ]}}_{\sqrt{W}} {\underbrace{[ \begin{matrix}f ( {x}_{1} , {y}_{1} ) \\ f ( {x}_{2} , {y}_{2} ) \\ ⋮ \\ f ( {x}_{{N}_{p}} , {y}_{{N}_{p}} )\end{matrix} ]}}_{b} \qquad Eq . ( 5 )$$

Defining Ã=\sqrt{W}A and \tilde{b}=\sqrt{W}b, we can use the same least-squares solution and pseudo-inverse in Eq. (4) to obtain the numerical derivatives, i.e.,

$$Z = {( {\tilde{A}}^{T} \tilde{A} )}^{- 1} {\tilde{A}}^{T} \sqrt{W} b = {\tilde{A}}^{*} \sqrt{W} b \qquad Eq . ( 6 )$$

Ã*\sqrt{W} will be the coefficients of the filter to be saved for future use. Hereafter, this one considering the weighted contributions from different neighboring pixels is named the weighted wide view filter.

### 3.0 Development of the Line Filter

While the wide view filter excels in gradient calculation in low SNR environments and offers a large range of benefits, it has one issue, i.e., the presence of low contrast boundaries along an edge. As expected, the contents and light intensities of an image vary across the image domain. This results in inconsistent broken boundaries and potentially weak areas along an edge that can result in missed detection.

Development started on the line filter with the idea of further improving the capabilities of the wide view filter, specifically the smooth detection of lines, to further improve the ability to detect gradients in the presence of extreme noise, and to produce a better orientation indication of any present edges. Because of this, the line filter is built on the same foundational principles as the wide view filter. The principal idea is to use many surrounding pixel values and a high-order (up to the 4th-order) Taylor expansion to compute all the derivatives along both the normal and the tangential directions at a target pixel. The line filter can improve upon the wide view filter by determining numerical derivatives at the target pixel using the weighted derivative values of multiple pixels along the line filter oriented in a specific direction. This way, the line filter can fill any low gradient areas along a line by using the high-gradient information along this line. In addition, by lengthening the filter, more image information is included in the neighborhood to achieve a higher fidelity gradient calculation under non-ideal noise conditions.

### 3.1 Line Filter Architecture

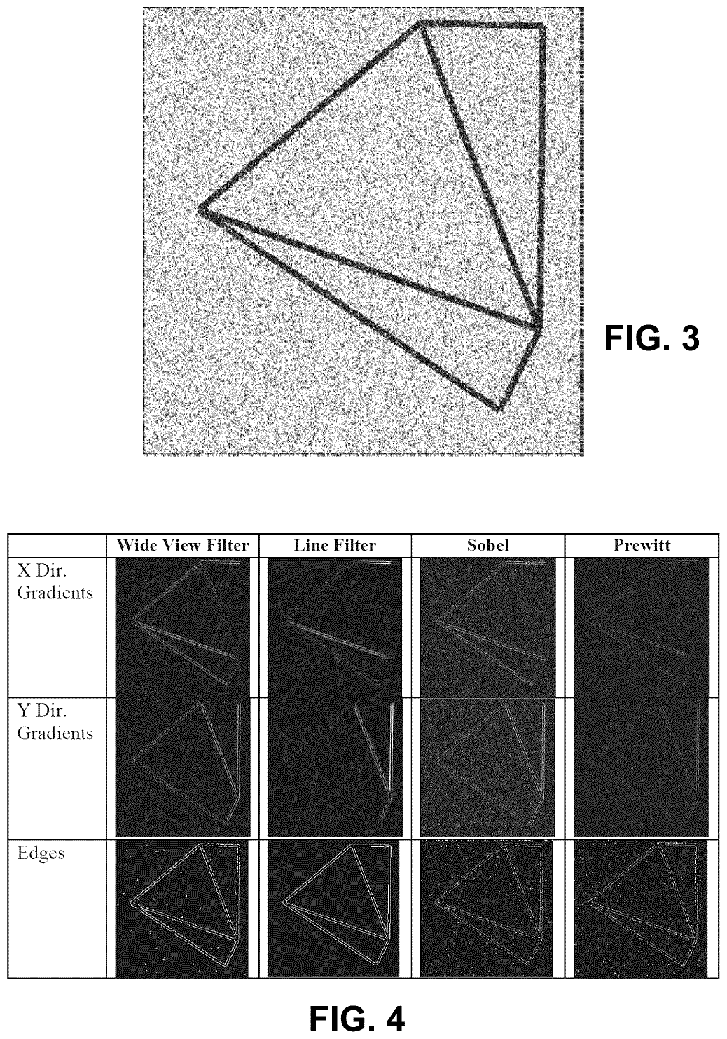

The line filter can be considered a string of wide view filters. One wide view filter will be centered on the indexed pixel with a user defined number of filters on both the left and right of the index. FIG. 2 illustrates an exemplary schematic of the local coordinate system with wide view filter layout of FIG. 1, and with a schematic of an exemplary presently disclosed line filter layout on the right-hand side of the illustration. FIG. 2 further illustrates the line filter conceptually, while its important aspects are described as follows:

1. A user-defined number of pixels (in yellow) are indexed along a line centered on a target pixel (in red). Hereafter, the red target pixel is termed the origin pixel as it denotes the origin of the local coordinate system (x, y). In most cases, the pixels on the line (in yellow) will not fall on real pixels and are therefore referred to as virtual pixels. The distance between virtual pixels on the line is spaced evenly and kept constant as “1” while the orientation of the line can be arbitrary. These virtual pixels pose no problem to computing derivatives because only their precise locations instead of their pixel intensity values are needed in the high-order Taylor expansion. The location of each virtual pixel along the line will be used to find its nearest neighbor pixels to run the wide view filter centered around this virtual pixel. The process outlined from the wide view filter can then be executed at each virtual pixel to yield the numerical derivatives along the line.

2. The wide view filter calculates one value of each derivative for every virtual pixel along the line, which means the line filter will contain multiple virtual pixels, all with multiple corresponding derivative values. The derivatives at the origin of the line filter are then calculated as the weighted average of those at the virtual line pixels. In this method, a set of weights can be applied to the derivatives at each virtual pixel. The origin pixel will hold the largest weight, while the pixels towards the end of each arm have very small weights, resembling a normal distribution. Alternatively, the weights can be disregarded for all virtual pixels to improve the connectivity of a subtle edge.

3. The line filter described in (1) and (2) will be applied at many different orientations, θ=i2n/nₛ, where nₛ is a user-defined number of lines to resolve the circumferential direction and i=1, . . . nₛ is the index. It is expected that when the line filter aligns with the edges in the image, the numerical derivatives will show the strongest values along the tangential direction. Once again, this demonstrates the capability to extract the exact orientation of an edge in a photo. In this case, the line filter should be even more capable of predicting angular information going forward as it contains more derivatives of an ensemble of pixels over the wide view filter, which can capture the original edge rotation.

### 3.2 Line Filter Algorithm

The line filter is implemented in MATLAB, and the numerical algorithms and procedures need to be delicately formulated to improve computing efficiency and to generate a single set of line filter coefficients (instead of iterative applications of multiple wide view filters), which is extremely important for practical utilization of the present line filter. It is expected that the line filter and wide view filters will be able to be parallelized to run efficiently on high-performance equipment. The numerical procedure is summarized as follows:

1. The half width of the line filter m is defined, and thus, the total length of the line is 2m+1 (also the number of pixels along the line). This indicates how many wide view filters are necessary to construct the wide view filter.

2. For each virtual pixel and the origin pixel, its neighbor pixels used in the wide view filter will be determined using the relative position between them and the origin pixel. This is because the origin pixel is a “real” pixel, and the relative positions between it and the neighbors of all virtual pixels are integers. This yields a set of the neighbor pixels (used in the wide view filter) for each virtual pixel, i.e., Δⱼ={(Δx, Δy)₁, (Δx, Δy)₂, . . . , (Δx, Δy)_{Np}}, where j is the index of the virtual pixel, and Np is the number of neighbor pixels for the j^{th} virtual pixel.

3. In order to create a single set of the line filter coefficients, we string together the neighbor pixels of all virtual and origin pixels in the form of a union, i.e., ω={Δ₁, Δ₂, . . . , Δ₂ₘ₊₁}. The total number of pixels in ω is N. This creates a single set that defines the range of the neighbor pixels for the entire line filter, whose intensity values will be used for computing derivates of the line filter.

4. Then, the intensity values of all pixels surrounding the line filter are given by

$$F = [ \begin{matrix}f ( {X}_{1} , {X}_{1} ) \\ ⋮ \\ f ( {X}_{i} , {Y}_{i} ) \\ ⋮ \\ f ( {X}_{N} , {Y}_{N} )\end{matrix} ] \qquad Eq . ( 7 )$$

where (Xᵢ, Yᵢ)=(X₀, Y₀)+ω (i), X₀ and Y₀ are the global coordinate of the origin pixel of the line filter, and Xᵢ and Yᵢ are the global coordinate of the i^{th} neighbor pixel in ω. Thus, the intensity values of neighbor pixels at the j^{th} virtual pixel can be easily retrieved by

$${F}_{j} = {P}_{j} F \qquad Eq . ( 8 )$$

where Fⱼ has a dimension of Np, the number of neighbor pixels around the j^{th} virtual pixel on the line filter; and Pⱼ is a selection matrix with a dimension of Np×Np and selects the neighbor pixels around the j^{th} virtual pixel out of all the neighbor pixels of the entire line filter. Note that Pⱼ is a submatrix of the identity matrix with a dimension of Np×Np.

5. The original equation used to calculate derivatives from a wide view filter can be slightly altered using the principle of the selection matrix in Eq. (8). The numerical derivatives zⱼ computed by the wide view filter around the j^{th} virtual pixel is given by:

$${Z}_{j} = {A}_{j}^{*} {F}_{j} = {A}_{j}^{*} {P}_{j} F \qquad Eq . ( 9 )$$

where Aⱼ* is the coefficients of the wide view filter at the j^{th} virtual pixel. Note that Aⱼ* is not constant for all virtual pixels because the relative positions between each individual virtual pixel and its neighbor pixels vary along the line. Therefore, Aⱼ* depends on j.

6. With all Aⱼ* available, the filter coefficient for the entire line filter can be written as

$$z = {w}_{1} {z}_{1} + ⋯ {w}_{j} {z}_{j} + ⋯ {w}_{2 m + 1} {z}_{2 m + 1} = {\sum }_{j = 1}^{2 m + 1} {w}_{j} {A}_{j}^{*} {F}_{j} = ( {\sum }_{j = 1}^{2 m + 1} {w}_{j} {A}_{j}^{*} ) F = {A}_{l} F \qquad Eq . ( 10 )$$

where Aₗ is the single set of coefficients for the entire line filter and varies with the orientation of the line filter and the number of the virtual pixels along the line.

### 4.0 Wide View and Line Filter Performance Analysis

It is hard to quantitatively evaluate the performance of gradient filters and edge detection processes as there are no ground truth values to compare to when analyzing complex images. Because of this, the performance of the Wide View Filter and Line Filter were qualitatively analyzed by performing gradient and edge comparisons to common methods. In these tests, the most important evaluation criteria are gradient smoothness, true edge gradient contrast, angular invariance, noise suppression, edge localization, and edge connectivity. All these metrics can be assessed with visual results.

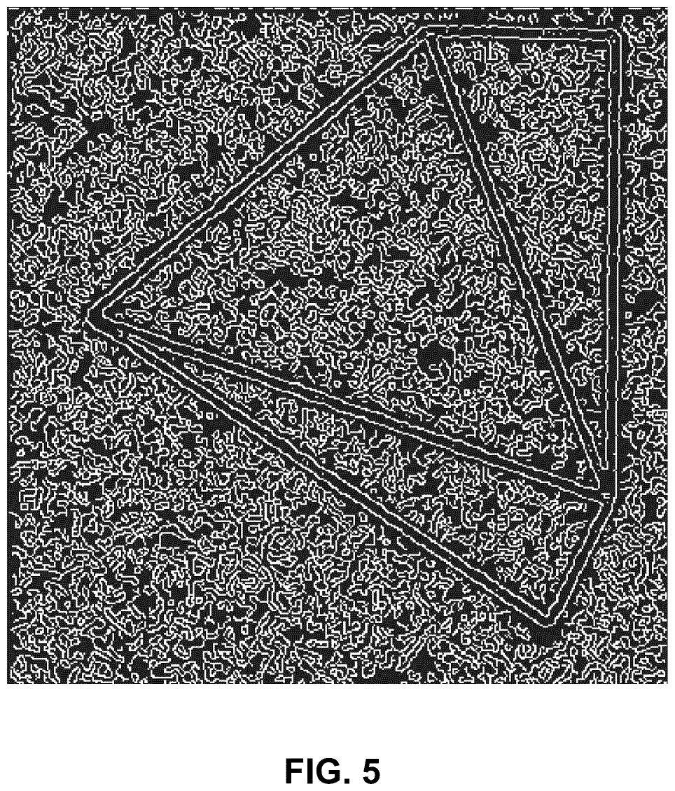

To properly cover all the evaluation metrics, three tests were developed and carried out. First, a synthetic image was generated with a constant signal-to-noise ratio and various lines at different angles to provide a baseline of the Wide View Filter and Line Filter's capabilities. FIG. 3 illustrates an exemplary synthetic line photo used for initial analysis of the wide view and line filter. This photo gives us a good baseline to evaluate the gradient calculation accuracies since all its parameters are known and adjustable. Because the parameters are manipulable, the synthetic photo can provide a stress test to determine the limits of the filter's abilities in the second test. A real-world photo is a sensor interpretation of the environment in front of it. Such a photo is affected by physical properties like depth, perspective, movement, and others. The Wide View and Line Filters have been tested on such photos in the third test to determine their efficacy in a real-world situation.

### 4.1 Synthetic Image Testing

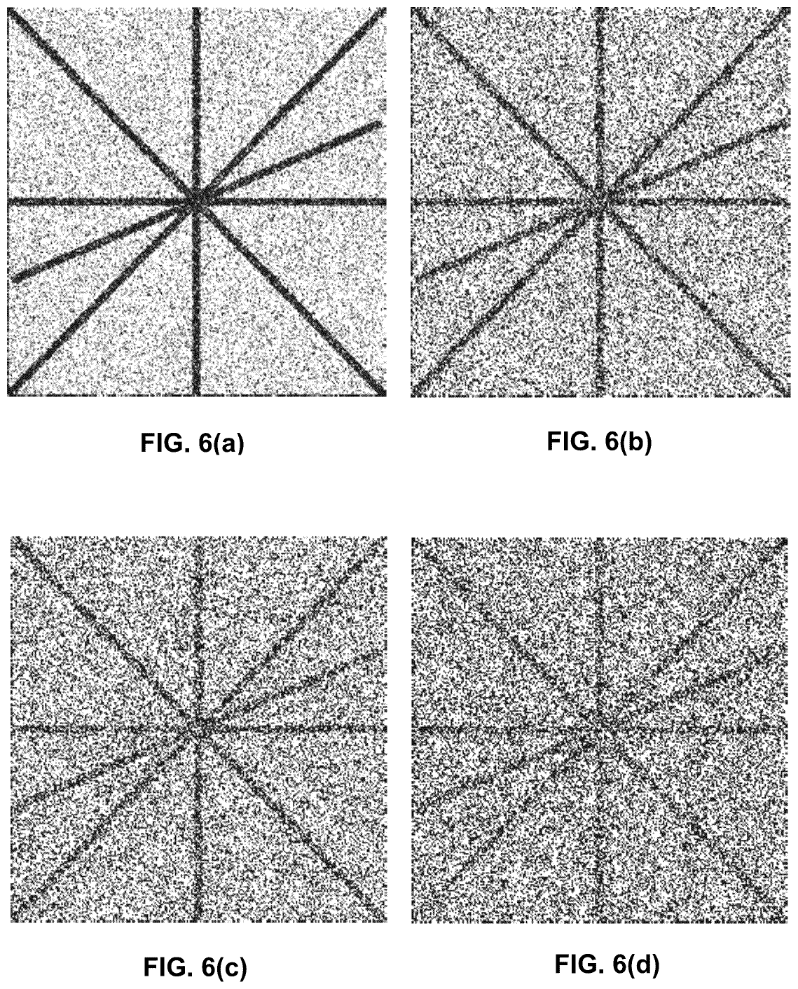

The synthetic line photo consists of a multi-line enclosed shape on a white background with salt and pepper noise tuned to a signal-to-noise ratio of two. An SNR of two serves as a challenging yet realistic scenario that the gradient filters may need to overcome in field operation. In addition, the variably oriented lines in the FIG. serve as tests to judge the angular fidelity of the filters. It is well known that commonly used gradient filters like Sobel and Prewitt lack significant accuracy in determining diagonal line gradients because they only estimate the magnitude using the gradients calculated at the local x and y positions. FIG. 4 is a tabular format illustration for comparison of presently disclosed gradients (both X and Y directions) and edges obtained with presently disclosed wide view and line filter subject matter, respectively, compared with results of Sobel and Prewitt kernels, all used for processing the synthetic line photo of present FIG. 3.

A few observations can be made from these results; however, it is important to understand what they mean before drawing any conclusions. Any lines and edges parallel to the x axes of the arbitrarily oriented filter will be undetected, while the lines perpendicular to the axes, i.e., the normal direction of the lines, will have the strongest detection. Second, lines in between the parallel and perpendicular directions of the axis will vary in intensity according to how close or far away its direction is from the normal direction. The closer the line is to the normal direction, the larger its derivative value will be. This specifically is why traditional gradient detection methods fall short. Using only x and y kernels can only guarantee accurate detection along those two directions. Anything in between them will be an assumption made from the local x and y gradients produced from the respective kernels. An edge in between the x and y gradients will produce smaller gradient values from those kernels and in turn be represented by an inaccurate smaller magnitude. This is one major reason the wide view and line filter can produce superior results. These filters can be oriented at any number of angles and produce gradients at a very fine angular resolution, meaning they leave nothing up to assumption.

Both the Prewitt and Sobel methods can detect gradients along the line in the photo. However, they are not very capable of separating those gradient values from the background noise. This conclusion can be made by comparing the relative intensities of those gradients to the salt and pepper-like noise surrounding them. This is especially true for the Prewitt method, which produces very muted values in general. Due to this phenomenon, the edge maps produced by their respective gradients maintain an intolerable level of false positives and broken edges. As is visible, all the true edges are very interrupted and lack any degrees of connectivity, which is paramount in any good edge map.

On the other hand, the wide view and line filters are very capable. The gradients show strong contrast to the noise levels in the background, and because of that, their edge maps show vast improvement over the competition. The wide-view filter produced edges show much better connectivity and noise suppression immediately, although it is noted that some false positives and breakages do persist. However, the line filter further improves the performance of the wide view filter. When properly aligned with an edge, the line filter can accurately detect a gradient even in the presence of strong noise. This means that no matter the orientation of edges in the original picture, the line filter will produce smooth and strong gradients, resulting in a noise-free/minimal and completely connected edge map.

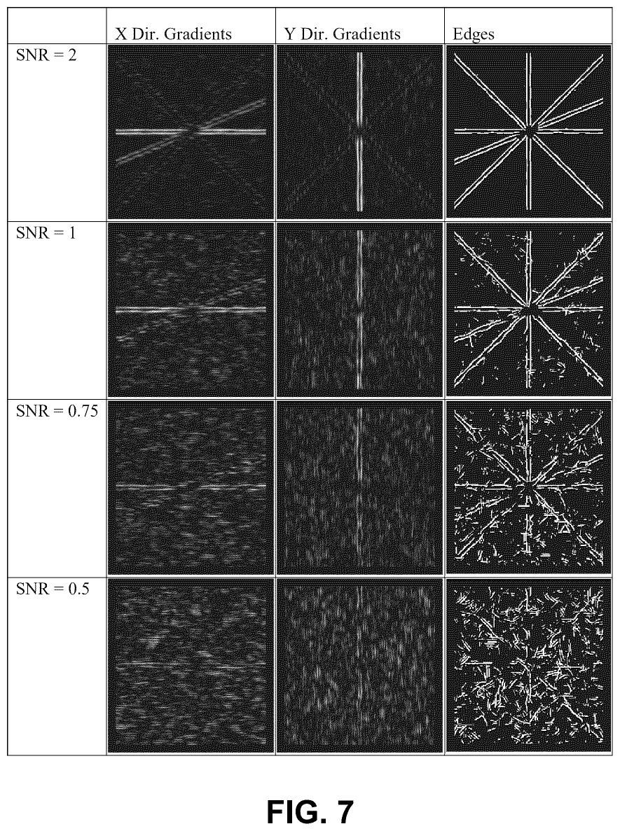

The Canny edge determination process is also highly regarded in traditional edge detection processes and is therefore important to consider in comparison with our filters. Canny filter does not produce gradients in any novel way and instead includes a process for obtaining edges from a gradient map. Because of this, Canny filter is usually used with the Derivative of the Gaussian method to define gradient intensities. FIG. 5 illustrates an exemplary Canny edge map produced from the synthetic line image of present FIG. 3, using the Derivative of Gaussian method. The edge map produced from this method and illustrated by FIG. 5 shows clean and connected edges on the synthetic line object itself. Even though it does produce very good edges on the object, as shown by FIG. 5, the result is completely degraded by noise.

### 4.2 Synthetic Image Signal to Noise Analysis

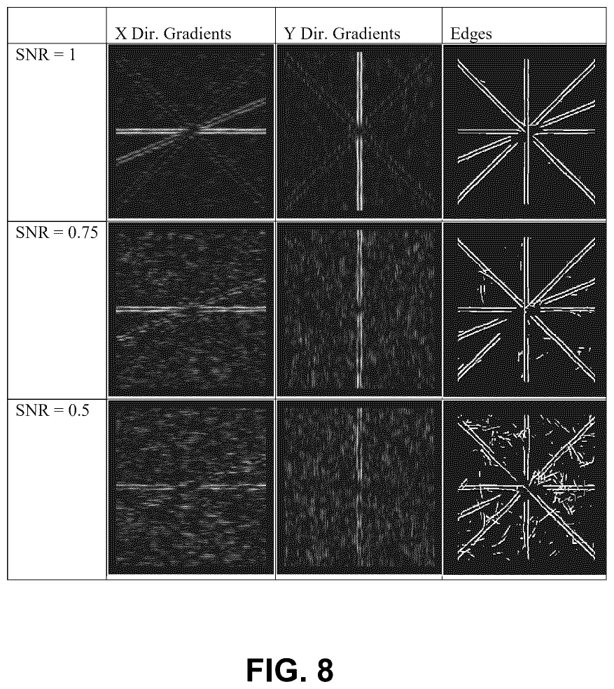

One of the most desirable features of the wide view and line filters is their ability to suppress noise. It is therefore important to gauge the limits of the filter's capabilities regarding gradient detection in extreme noise. Another synthetic line photo was generated for this purpose so that the known SNR values could be changed and then used with presently disclosed filters. A set of the new synthetic line photos is given in FIGS. 6(a) through 6(d). The set of FIGS. 6(a) through 6(d) starts with the lowest SNR at two, which is the same as the synthetic line photo used in section 4.1. We know that the line filter is already capable of handling such a noise level, which is why it has been chosen as the starting point for this test. The set then progressively degrades all the way down to an SNR level of 0.5, with FIGS. 6(a) through 6(d) respectively having SNR levels of 2.0, 1.0, 0.75, and 0.5. An SNR level of 0.5 represents a worst-case scenario as the lines are significantly degraded by noise, they are hard to see even with normal human vision. It also serves to evaluate how changing parameters of the filter architecture can alter the gradient results and adapt to harsh conditions.

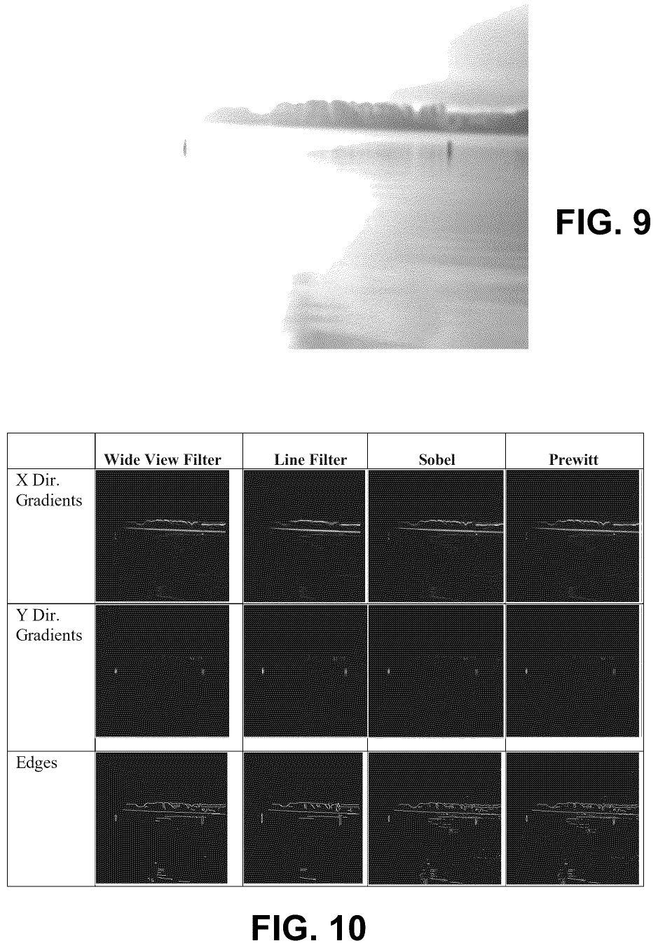

Using a base configuration of the line filter, decent results can immediately be obtained. These can be viewed in FIG. 7, which is a tabular format illustration for comparison of presently disclosed gradients and edges obtained with a base configuration of the line filter subject matter produced from a multi-line photo, respectively, for SNR levels of 2.0, 1.0, 0.75, and 0.5. The gradients and edges produced from the multi-line photo with an SNR of two are extremely accurate. The final edge map is extremely clean, containing no false positives and no line breakages. As the SNR decreases, the quality of gradients and edge also does. Edges are still visible at an SNR of one, however they are broken and very messy due to the noise. This result is still promising, however as an SNR of one is hard for detection in the real world. It represents a situation, in which the image noise would be equal to the image signal from the sensor. This is highly unlikely, however not impossible, and should still be addressed. As expected, further decreasing the SNR results in very messy edges with almost undetectable true edges in the final edge map.

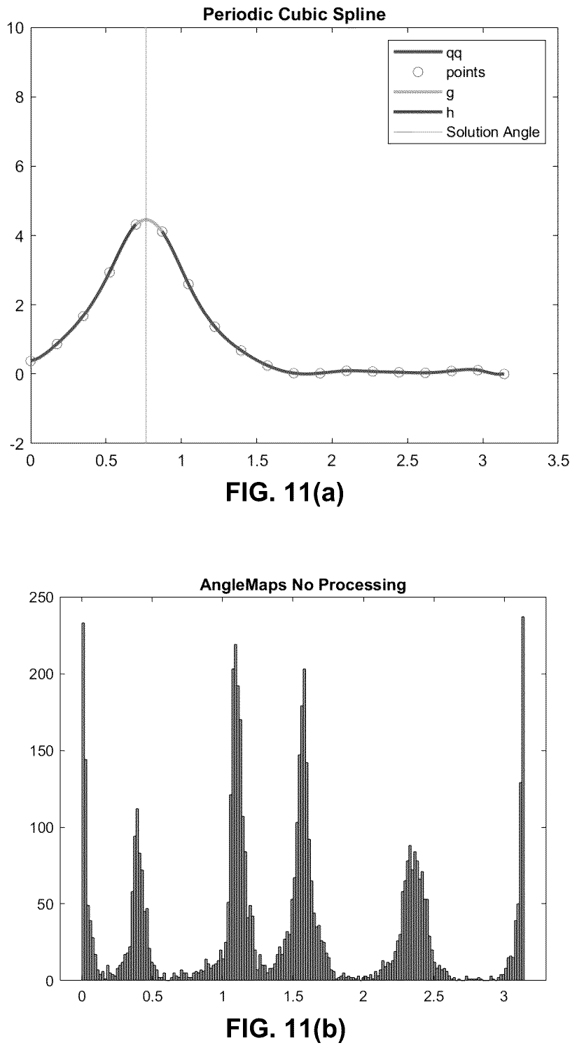

The gradient and edge fidelity from FIG. 7 be improved by increasing the filter size. Doubling the length of the line filter and the number of neighborhood pixels used previously allows us to obtain extremely robust results. This yields a line filter with a length of 29 pixels, and 250 neighborhood pixels per wide view filter which is very capable of handling an SNR level of one. It can even obtain smooth and accurate edges at an SNR of 0.75. As the SNR falls to 0.5, the edge map degrades significantly, though it can capture the general geometry of the multi-line object that it was not able to do before. These are clear in FIG. 8, which is a tabular format illustration for comparison of presently disclosed gradients and edges obtained with larger filter size subject matter produced from a multi-line photo, respectively, for SNR levels of 1.0, 0.75, and 0.5.

Doubling the line filter size does not significantly increase the computational cost, and more importantly, it can be parallelized, so it can be assumed that further increasing the filter size will allow us to further enhance edge detection at outrageous SNR levels. It is also extremely important to note that these results can be obtained without the need to use any smoothing filters. All gradients and edges are obtained using the original photo information to preserve the image integrity and use it at face value. Sobel, Prewitt, and Canny would all need to apply some sort of smoothing filter before they could handle images with an SNR level of 2. The line filter, on the other hand, can handle significantly worse scenarios without the smoothing filter.

### 4.3 Real Image Testing

The Wide View and Line Filter prove to be very capable as evidenced from the synthetic photo results and SNR analysis. However, these filters are designed with the idea of real world deployability in mind, and therefore, must be tested on representative data. On of the most challenging environments facing the image processing industry to date is the aquatic environment for several reasons. First and foremost, water is an ever changing environment, which impacts the stability of the scene and any objects present in it. In addition, physical phenomena in this environment can significantly degrade photos, such as specular reflection, high dynamic range, and weather-related events.

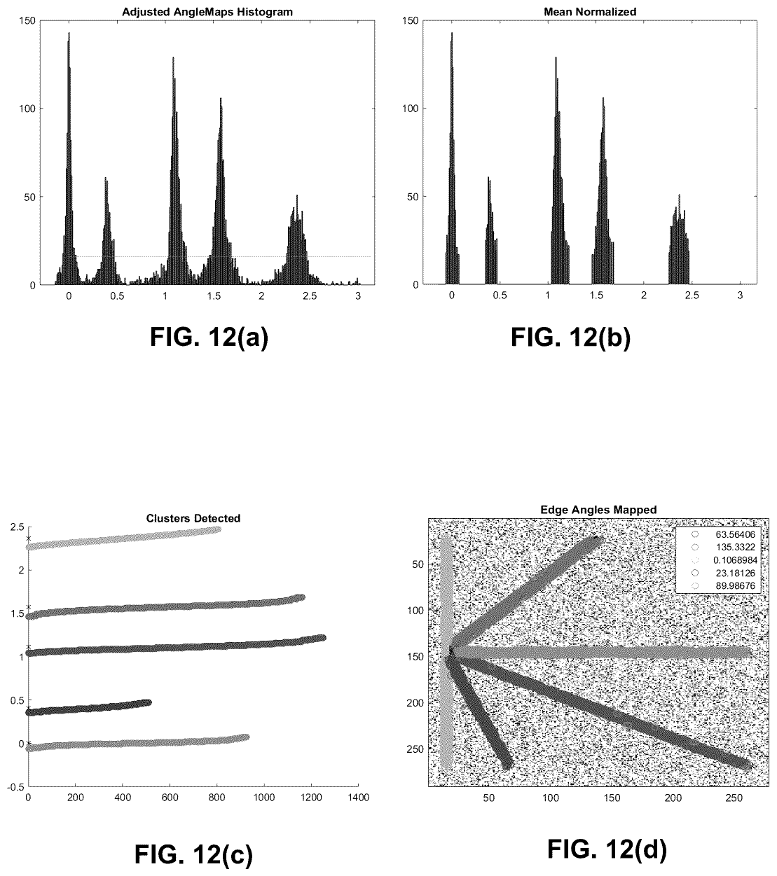

Processing a photo of an aquatic environment means the filters can be stress tested and properly assessed. For these reasons and more, it was desired to test the capabilities of both filters in a similar environment. FIG. 9 is an exemplary highly washed-out image of a body of water (Lake Murray, South Carolina). This photo provides a few objects to detect while simultaneously presenting an extreme lighting scenario across the length of the photo. The lighting variation creates harsh reflection on the left-hand side of the photo and almost washes out the buoy in that region. The lighting transition moving to the right-hand side of the photo creates a range of gradient data. These characteristics would normally challenge gradient-based filters; however, the wide view filter and line filter prove to be quite capable.

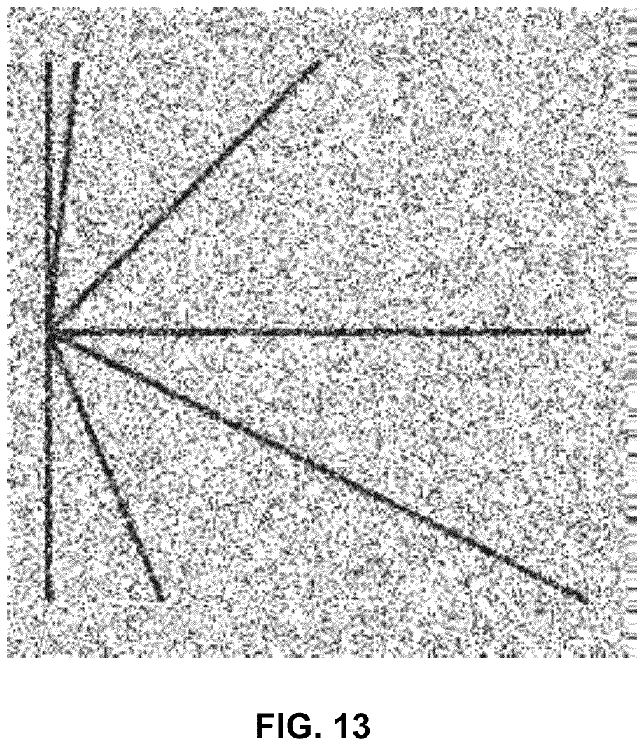

FIG. 10 is a tabular format illustration for comparison of presently disclosed gradients and edges obtained with presently disclosed wide view and line filter subject matter, respectively, compared with results of Sobel and Prewitt kernels, all used for processing the exemplary highly washed-out aquatic image photo of present FIG. 9. From this, a few conclusions can be drawn. First and foremost, the wide view and line filters are both capable of small object detection. Even in the sub-optimal lighting conditions of the photo, both buoys can be easily detected. It can be asserted that the wide view filter is better than the line filter in this respect because the wide view filter is smaller, and therefore, introduces less pixel information unrelated to the object in the gradient calculation. When observing the x direction gradient results between the two, it can be seen that the line filter does not produce visible gradient information. That is due to the relatively small size of the buoy edge (i.e., the top of the buoy) in comparison to the filter size in the x direction. This, however, comes with a drawback in that it is more susceptible to noise, which is visible when comparing the two filter's gradient and edge results in FIG. 10. Both the line filter and wide view filter however, show significant noise suppression in their results as compared to Sobel and Prewitt. This is evident that fewer broken edges are detected in the water body. Finally, both in-house filters show the ability to emphasize line edges and repair small breaks since they look over a larger area in the photo. Small interferences in long smooth lines like those of the horizon do not cause difficulty to either the wide view or line filter.

### 5.0 Leveraging Both Filters for Accurate Edge Angle Detection

Traditional gradient calculation kernels only consider gradients in the x and y direction. While these will produce generally accurate gradients in the x and y directions, anything in between must be estimated. Typically, this is done using an arctan of the calculated x and y gradients, which, however, is extremely unreliable. If an image consists of one line at a 45-degree angle, taking the arctan of the x and y gradients will suffice. However, there are many factors that will produce a highly inaccurate angle estimation when this approach is used. For one, the photo may contain severe levels of noise, which corrupt the gradient calculations and in turn induce error in the angle calculation. In addition, the discrete nature of the image domain combined with the small size of commonly accepted gradient detection kernels introduces significant inaccuracies.

Sampling from a discreet domain means the data used is limited to a specific set of values and corresponds to a certain resolution. This limits the set of angles that can be perfectly represented by an image and subsequently captured in a kernel. When considering this in addition to the 90-degree separation of the x and y gradients, it is nearly impossible to estimate an edge's angle with any degree of acceptable error. The wide view filter and line filter aim to address these problems. Because the wide view filter and line filter can consider a significantly larger area in its gradient calculation, it is much less susceptible to noise and able to represent a finer resolution in this discrete domain (without inter-pixel interpolation).

On top of that, the wide view and line filters can calculate gradients in an infinite number of directions depending on their size. This means the filters are capable of producing gradients directly from an edge at any arbitrary angle rather than interpolating them. These properties allow the filters to estimate edge angle within one degree of accuracy.

### 5.1 Using Cubic Spline to Calculate Angle at a Single Pixel

The general idea in accomplishing this is to use the line filter or wide view filter to calculate the derivative values of each pixel at various orientation angles. All the derivative values produced by the line filter can then be used as data points along with their respective angle values to form a smooth function describing the relationship between filter orientation and gradient value. These data points are used to fit a cubic periodic spline which establishes the relationship between the derivative values and the orientation angles. Cubic periodic splines are capable of fitting piecewise functions to bridge data points which are smooth about the first and second derivative. This results in a smooth flowing function describing an entire set of data. In this case, it can then be used to calculate where the maximum derivative occurs for a specific pixel. Finding the maximum value in the cubic spline, or the point in which its slope is zero will correspond to a specific angle along the function. This means the filter angle that produces the maximum gradient at a given pixel can be estimated.

### 5.2 Angle Detection Process

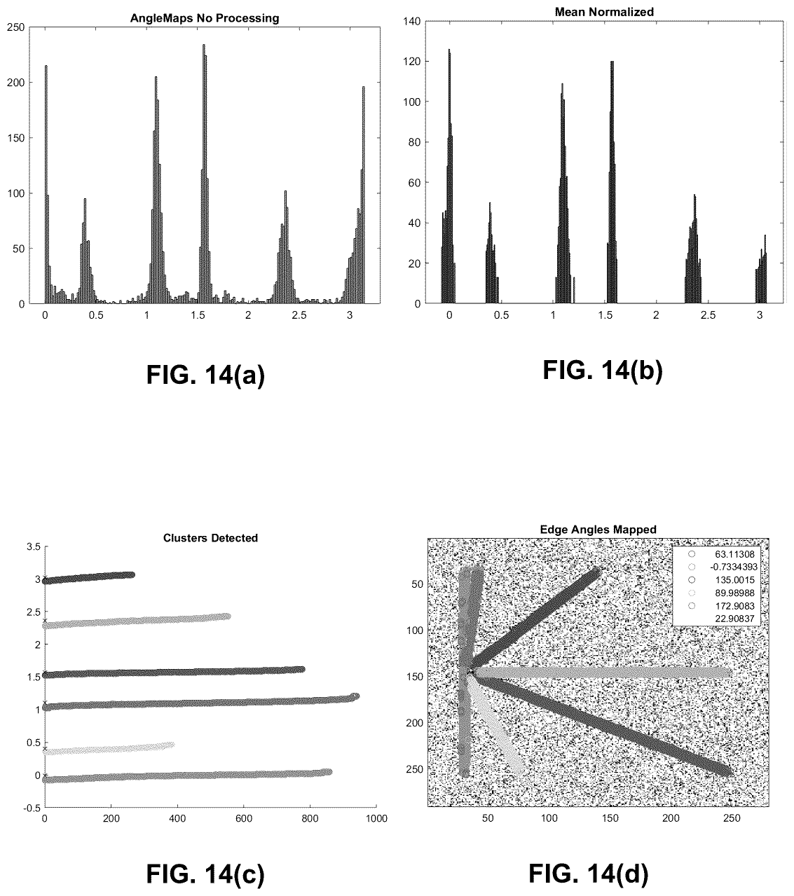

FIGS. 11(a) and 11(b) illustrate the first stage of presently disclosed angle detection procedure, illustrating a cubic spline for one pixel contributing to the histogram containing all pixel angle values for an image, with FIG. 11(a) graphically representing a set of piecewise function continuous to the second derivative, and with FIG. 11(b) graphically representing a histogram displaying the frequency of all the angles calculated in the image.

1. The line filter is first run at a user specified number of angles, defining the angular resolution. The derivative maps produced by the line filter at this angular resolution are fed in as the input of the angle detection script.

2. The angle detection script parses through each pixel of the derivative maps to produce a histogram of all the angles calculated for each pixel in the scene. Each pixel will have multiple derivative values calculated at various orientations by the line filter. These derivative values along with the orientation of the line filter that produced them provide the data point to build the periodic cubic spline at the indexed pixel.

3. The spline provides a set of piecewise function continuous to the second derivative (FIG. 11a). This can be leveraged to find the angle value, which produced the maximum derivative value for the pixel. First, the maximum derivative that the line filter was able to produce is found and then indexed on the spline. Because each gradient produced by the filter becomes a midpoint between two piecewise functions on the spline, the two surrounding the maximum derivative value must be analyzed. The piecewise functions that precede this value and come after are examined for zero slope values along their respective intervals. Zero slope locations correspond to local minimums and maximums on the spline. Only one zero derivative value should exist for the two functions when analyzed over their respective domains.

4. The angle location at which the derivative zero value occurs is defined as the angle of the edge as that is where the maximum derivative occurs. In cases where the indexed pixel lies on an edge, the derivative values will be large and easy to process. However, in cases where the pixel lies in noise or in the background, the derivative values will be much smaller and fluctuate dramatically with the orientation angle. By measuring the range of the derivative values produced on a pixel's spline and comparing them to the overall range of derivatives found in the image, the indexed pixel can be disregarded if its derivative range is too small.

5. After the angle is calculated for the indexed pixel, the script moves to the next pixel in the image and repeats the process to calculate its angle. All the calculated angles are then stored in a two-dimensional matrix which will be used to create a histogram displaying the frequency of all the angles calculated in the image (FIG. 11b).

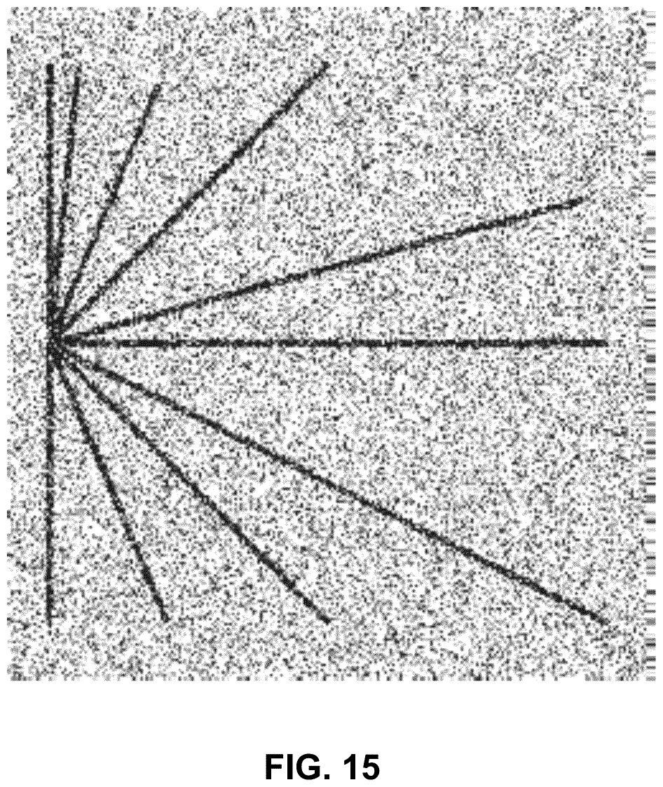

After this histogram is created, the script performs a set of post processing operations to clean the data and eventually cluster all the angles to match the edges in the image. FIGS. 12(a) through 12(d) represent steps in postprocessing flow of the presently disclosed angle detection script, including with the mean of the histogram data calculated and any bins with occurrences smaller than the mean disregarded (as graphically represented by FIG. 12(a)), then removing background pixels with random noises in the images as they do not exhibit dominant angle detections (as graphically represented by FIG. 12(b)), with the data then clustered into groups, which correspond to edges found in the image (as graphically represented by FIG. 12(c)), and lastly with any pixels within a cluster remapped onto the image to visualize their final calculated angles (as graphically represented by FIG. 12(d)). Additional details of the steps in the presently disclosed postprocessing flow are further discussed herein.

1. The first step in postprocessing is to separate any edges found to be at 180 degrees from the other data in the 170-to-180-degree range. This is because 180 degrees is geometrically equivalent to 0 degrees and any edges at 180 degrees should only be classified as 0 degrees. To separate the data at 180 degrees, the data is analyzed at a small scale of only 10 degrees, which searches for any peak values in the data preceding the 180-degree bin. Any peak values in the data indicate a decrease in the frequency of pixels in the subsequent bin and mark a point where the data can be separated. Sometimes no peaks can be found, and the data is instead clustered and examined for any clusters falling within a tolerance of ½ the angular resolution to 180 degrees. If either a peak is found or a cluster is calculated within the tolerance to 180 degrees, then the pixels after the peak or the pixels in the cluster are shifted to 0 by subtracting π from their angle values.

2. Once the histogram has been shifted, the data should be cleaned up to facilitate use of the clustering method. The mean of the histogram data is first calculated and any bins with occurrences smaller than the mean are disregarded (FIG. 12(a)). This will remove the background pixels with random noises in the images as they do not exhibit dominant angle detections (FIG. 12(b)).

3. After the noisy data is removed from the histogram, the data can be clustered into groups, which correspond to edges found in the image (FIG. 12(c)). Any pixels within a cluster can then be remapped onto the image to visualize their final calculated angles (FIG. 12(d)).

### 5.3 Angle Detection Results and Analysis

To determine how accurate angle detection is, the process was first tested on a variety of synthetic images. The synthetic images provide a measurable ground truth which can be used to compare against the outputs of the program. They also allow testing on a variety of cases which can represent challenges that often arise in the real world like closely aligned but still distinct edges and extremely low signal to noise ratios. The worst possible case for angle detection would be a dimly lit scene with many objects in close proximity, however such a situation cannot be used for testing as no measurable ground truth can be determined after the scene has been captured in a photo. Synthetic line tests allow for replication of these challenging conditions so that the accuracies in such situations can be predetermined, and confidence can be ensured when using the program.

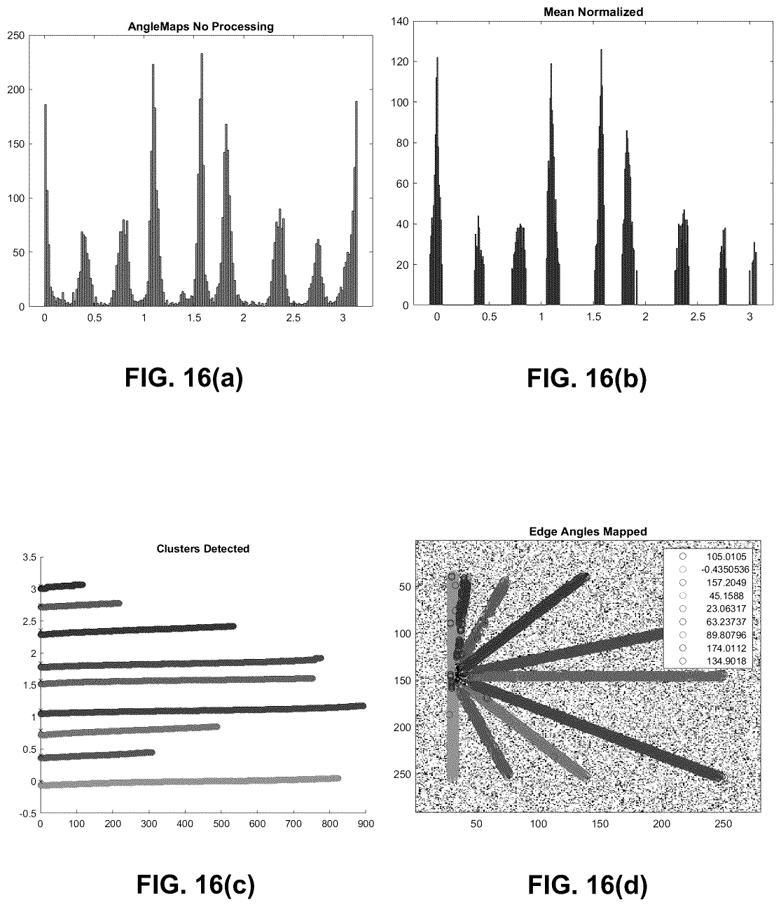

The first image tested with the angle detection script is a multi-line image consisting of variably oriented lines with two closely aligned to each other. The purpose of using this image is to gauge the script's performance in detecting the angle of two lines with similar angles and being able to separate them. FIG. 13 illustrates a synthetic line image pertinent to presently disclosed subject matter as otherwise discussed herein. This photo in FIG. 13 has also been corrupted with a signal to noise ratio of two to further complexify the test.

Similar to the illustrations of FIGS. 12(a) through 12(d), respectively, FIGS. 14(a) through 14(d) represent, respectively, steps in postprocessing flow of the presently disclosed angle detection script, in the case of a subject multi-line photo with close lines angle detection results at a 10-degree angular resolution. The subject script performed very well on the synthetic line image and achieved desired results immediately. The results are presented in Table 1 and FIGS. 14(a) through 14(d). Table 1 contains the numerical results for each edge in two formats. The cluster center angle represents the average angle of all the pixels included in its group while the peak angle represents the most frequent angle appearing in a group. In most cases, the cluster center is more reliable.

TABLE 1
Numerical comparison of calculated angles
at 10-degree angular resolution

| True Angle | Cluster Center Angle | Cluster Peak Angle |
|---|---|---|
| 0 | −0.733 | −0.527 |
| 23 | 22.908 | 22.426 |
| 63.5 | 63.113 | 62.120 |
| 90 | 89.990 | 90.241 |
| 135 | 135.002 | 135.848 |
| 174 | 172.908 | 174.855 |

These were obtained running the line filter once every 10 degrees from 0 all the way to 180. The angles for each line fall well within the tolerance range of plus or minus one degree from the true value aside from line at 174 degrees. Even still, the estimated angle for this line is only slightly out of range at 1.1 degrees. On top of this, the lines at 174 degrees and 180 degrees can be reliably separated. Some pixels are falsely identified in the wrong angle group; however, this is a result of the noise skewing their true value and does not occur frequently enough to cause issue.

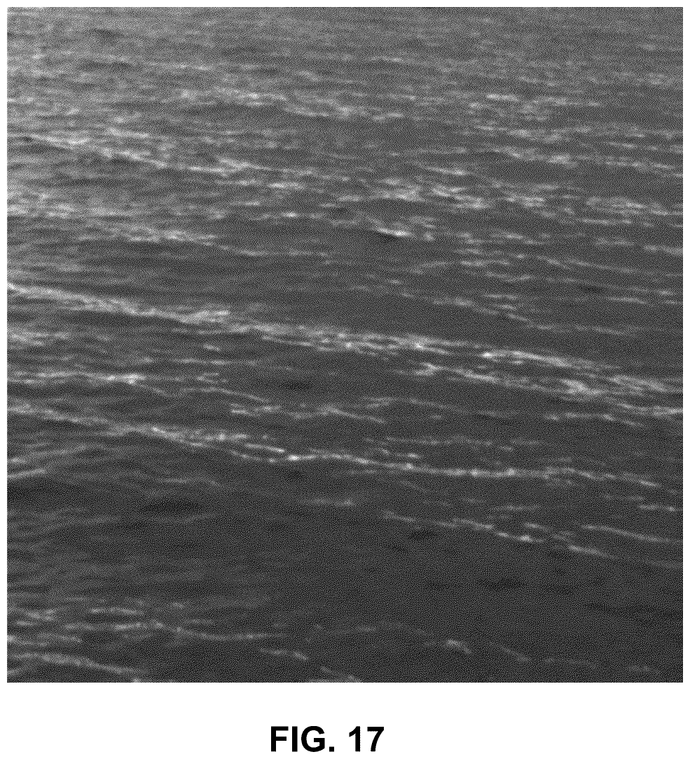

While the previous photo presented a case to test the separation capabilities of the angle detection process, we wanted to ensure the capabilities by using another compact synthetic line photo with an even more difficult case. In particular, FIG. 15 illustrates an exemplary dense synthetic line image pertinent to presently disclosed subject matter as otherwise discussed herein. The FIG. 15 photo contains many more lines and decreases the overall separation of every line in the photo. This serves as a test of overloading the histogram with peaks to examine the performance of the clustering method. The angle detection script again had no problem handling this image and produced accurate results within half a degree of the true angle for each of the lines in the photo. Similar to the illustrations of FIGS. 14(a) through 14(d), respectively, FIGS. 16(a) through 16(d) represent, respectively, steps in postprocessing flow of the presently disclosed angle detection script, in the case of a subject dense multi-line photo (FIG. 15) with close lines angle detection results at a 10-degree angular resolution. The results are presented in Table 2 and FIGS. 16(a) through 16(d). Somewhat surprisingly, in this case, the same two lines at 174 and 180 degrees from the previous test, were more separable. This could be caused by a number of factors but is most likely a result of the clustering algorithm which is more attuned to create smaller groups of angles for this photo since it contains many lines of varying sizes as compared to the previous photo.

TABLE 2
Numerical comparison of calculated angles
at 10-degree angular resolution

| True Angle | Cluster Center Angle | Cluster Peak. Angle |
|---|---|---|
| 0 | −0.435 | −0.573 |
| 23 | 23.063 | 22.598 |
| 45 | 45.159 | 44.118 |
| 63.5 | 63.237 | 62.504 |
| 90 | 89.808 | 90.126 |
| 105 | 105.011 | 104.479 |
| 135 | 134.902 | 135.447 |
| 157 | 157.205 | 157.930 |
| 174 | 174.011 | 174.431 |

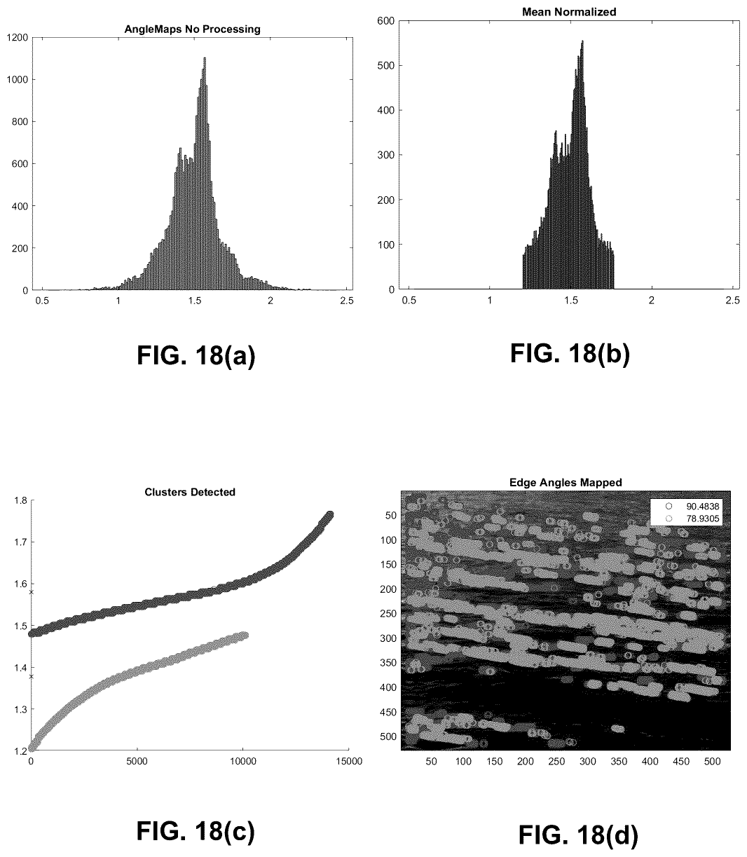

Similarly, to the wide view and line filter results analysis, it is desirable to test the angle detection algorithm on a real-world photo to ensure it has the potential to be used in real applications. The next exemplary photo tested therefore was a photo of Lake Murray wave field, as shown in FIG. 17. The FIG. 17 image was chosen because it provides a few interesting challenges for applying the angle detection script. The angle detection script could be useful in scenarios, where additional environmental data is necessary. In the case of the FIG. 17 exemplary Lake Murray image, highly accurate angular data can reveal trends and information regarding the wave field direction, possible subsurface obstacles, and direction of the underwater currents. This can prove to be challenging especially for photos like this because waves are a noisy group of objects to track and are constantly changing.

Interestingly, the angle detection script was able to extract features not readily visible to the naked eye. According to the photo, it appears there is one dominant direction that the wave crests are orientated and traveling at. What is not apparent is that a secondary wave field exists, which the angle detection script can capture. When we zoom in on the photo, each wave field is visible. Similar to the illustrations of FIGS. 16(a) through 16(d), respectively, FIGS. 18(a) through 18(d) represent, respectively, steps in postprocessing flow of the presently disclosed angle detection script, in the case of the exemplary aquatic wave field photo (FIG. 17) with close lines angle detection results at a 10-degree angular resolution. FIGS. 18(a) through 18(d) and Table 3 show the angle detection script at a 10-degree angular resolution. Because the image is not man made, there is no known ground truth to compare the estimated angles with. With the enlarged view, however, the calculated angles appear very close to what can be visually estimated and measured after capture.

TABLE 3
Numerical comparison of calculated angles
at 10-degree angular resolution

| Cluster Center Angle | Cluster Peak Angle |
|---|---|
| 78.931 | 79.985 |
| 90.484 | 89.347 |

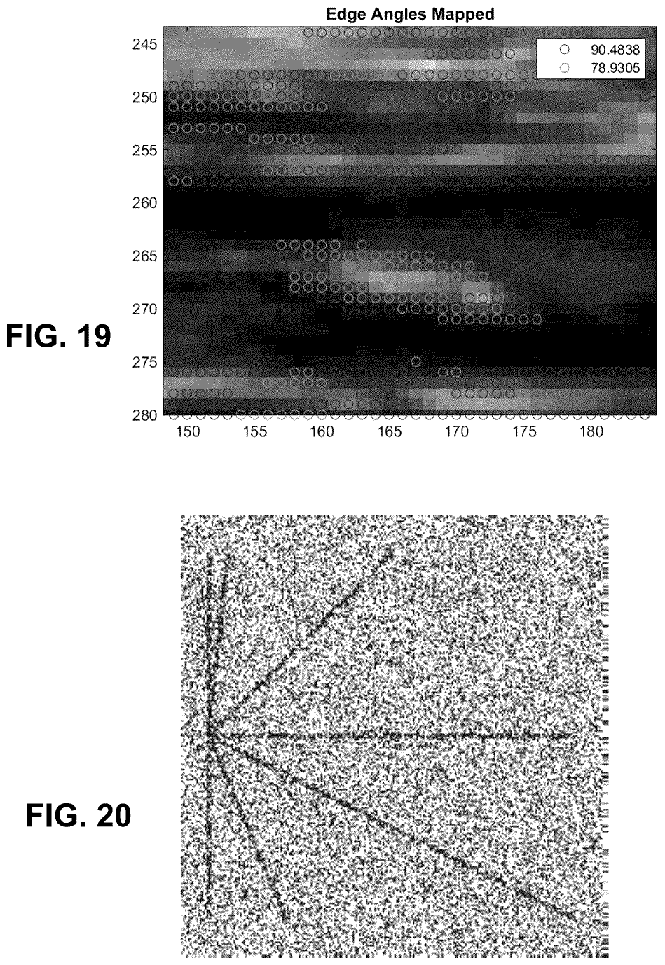

As stated, the angle detection script can reveal a second wave field which cannot be visually extracted without prior indication. FIG. 19 is a zoomed in view of the FIG. 17 image of an exemplary wave field of a body of water (Lake Murray, South Carolina), and therefore FIG. 19 shows a better visual to observe this. One dominant wave field overpowers the smaller secondary in the large picture, while in the zoomed in version there are two dominant directions of the waves. Over time in the frame sequence, these two directions can be confirmed as the waves travel orthogonally to their dominant direction.

FIG. 20 is an exemplary synthetic line image of the aquatic subject matter of Lake Murray (South Carolina). This last photo tested by the angle detection script is a lower SNR version of the second multiline photo tested, used to gauge the capabilities of the angle detection script when presented with a wholly noisy photo. Without changing the configurations of the line filter of angle detection script, the results came out quite inaccurate. This is somewhat expected as all previous photos had been somewhat standard scenarios, and analyses from the filters themselves have shown that increased filter sizes are necessary to suppress more noise. Because of this, the line filter size had to be increased to a length of 29 pixels and a neighborhood size of 150 pixels per wide view filter. Similar to the illustrations of FIGS. 18(a) through 18(d), respectively, FIGS. 21(a) through 21(d) represent, respectively, steps in postprocessing flow of the presently disclosed angle detection script, in the case of a multi-line exemplary synthetic line image of aquatic subject matter (FIG. 20) with close lines and low SNR angle detection results at a 10-degree angular resolution (Np=150 & Filter Size=29 px). The results using this configuration can be seen in FIGS. 21(a) through 21(d) and Table 4. An increased filter length both reduced the number of false detections among the noise and improved the accuracy of the detected angles. The final angle calculations all came within the desired one degree of tolerance, and many of them were significantly closer. Even though the filter had to be increased in size, the calculations were done with a similar computational efficiency as compared to the original size filter. This means the highly accurate angle calculations came with minimal additional costs.

TABLE 4
Numerical comparison of calculated angles at 10-degree angular
resolution with a 29-pixel filter length and Np = 150

| True Angle | Cluster Center Angle | Cluster Peak Angle |
|---|---|---|
| 0 | 0.075 | −0.057 |
| 23 | 22.303 | 22.632 |
| 63.5 | 63.139 | 61.564 |
| 90 | 90.003 | 89.742 |
| 135 | 134.443 | 133.912 |
| 174 | 174.074 | 174.815 |

### 6.0 Conclusion

The wide view filter demonstrates great promise for edge detection in these case studies, and there are several important observations worth pointing out. The use of the wide view enables an effective means of suppressing noise in low SNR images; second, by examining the tangential and the normal direction of the filter (viz., the local axes orientation), necessary directional information for object edges can be extracted, making edge detection direction-selective; and last, using a wider view, i.e., more surrounding pixels enhances noise suppression and increases the contrast ratio between the signals and the noises and connectivity between scattered edges, while making the edge thicker.

The line filter builds upon the promise that the wide view filter displayed. The results presented show that the line filter exhibits strong edge detection when it aligns with the edges, and therefore, it can be used to accurately determine the direction of the lines with proper postprocessing. Additionally, it shows a large improvement of connecting broken edges over the wide view filter. When the line filter is placed at the correct orientation for an edge it should be able to increase the amount of information that may have otherwise been lost due to noise or obstructions. In addition, the SNR analysis performed shows that the line filter is proficient in handling large noise levels in a photo. Notably, the line filter can handle noise levels previously impossible to work with when using traditional gradient operators. The architecture of the line filter allows it to be adapted to many scenarios it may encounter and should be able to handle real-world levels of noise when using the right configurations. Developments with the line filter can be made, including an angle detection algorithm to work in conjunction with the line filter, which will reveal the orientation of an edge with a high degree of accuracy.

The first stage of angle detection proves to be flexible, adaptable, and accurate. When combined with a sufficient line filter configuration, angles can be determined to within one degree of their true value every time even with very low quality of the image. This accuracy is unachievable without the use of the line filter and associated angle detection methods even with pristine images.

It should be noted that the current implementation of angle detection can likely be improved from a computational aspect. The script is run for every pixel in an image despite its edge status. This results in a lot of wasted computation for pixels which do not require angular determination. An easy and efficient fix for this would be to perform edge determination before and gather the indices of the edges. This set of indices would serve as the domain for angle detection to take place.

This written description uses examples to disclose the presently disclosed subject matter, including the best mode, and also to enable any person skilled in the art to practice the presently disclosed subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural and/or step elements that do not differ from the literal language of the claims, or if they include equivalent structural and/or elements with insubstantial differences from the literal languages of the claims. In any event, while certain embodiments of the disclosed subject matter have been described using specific terms, such description is for illustrative purposes only, and it is to be understood that changes and variations may be made without departing from the spirit or scope of the subject matter. Also, for purposes of the present disclosure, the terms “a” or “an” entity or object refers to one or more of such entity or object. Accordingly, the terms “a”, “an”, “one or more,” and “at least one” can be used interchangeably herein.

### REFERENCES

Lin, W., & Wang, J., (2017) Edge detection in medical images with quasi high-pass filter based on local statistics. Biomedical Signal Processing and Control, 39, 294-302. https://www.sciencedirect.com/science/article/pii/S1746809417301751
N. Ofir, M. Galun, B. Nadler & R. Basri, (2016) Fast Detection of Curved Edges at Low SNR. IEEE Conference on Computer Vision and Pattern Recognition (CVPR), 213-221. https://ieeexplore.ieee.org/document/7780399
Bhardwaj, S., & Mittal, A., (2012) A Survey on Various Edge Detector Techniques. Procedia Technology, 4, 220-226. https://www.sciencedirect.com/science/article/pii/S221201731200312X
Forsyth, D. A., & Ponce, J. (2012). Computer Vision: A Modern Approach. (M. Hirsch, Ed). Upper Saddle River, NJ: Pearson Education.
Jahne, Bernd, (2002). Digital Image Processing. University of Heidelberg Interdisciplinary Center for Scientific Computing, Heidelberg, Germany
Kekre, H. B., & Gharge, Saylee (2010). Image Segmentation using Extended Edge Operator for Mammographic Images. International Journal on Computer Science and Engineering (IJCSE), 2(4), 1086-1091. https://www.researchgate.net/publication/49619233_Image_Segmentation_using_Extended_Edge_Operator_for_Mammographic_Images
Bogdan, Victor, & Bonchis, Cosmin, & Orhei, Ciphran (2019). Custom Extended Sobel Filters. https://www.researchgate.net/publication/336207994_Custom_Extended_Sobel_Filters
A. B. da Silva, Eduardo, & Mendonca, Gelson (2005). Digital Image Processing. The Electrical Engineering Handbook, 891-910. https://doi.org/10.1016/B978-012170960-0/50064-5
Guo, Yanming, & Liu, Yu, &, Oerlemans, Ard, & Lao, Songyang, & Wu, Song, & Lew, Michael (2016). Deep learning for visual understanding: A review. Neurocomputing, 187(26), 27-48. https://doi.org/10.1016/j.neucom.2015.09.116
Sun, Rui, & Lei, Tao, & Chen, Qi, & Wang, Zexuan, & Du, Xioagang, & Zhao, Weiqiang, & Nandi, Asoke K. (2022). Survey of Image Edge Detection. Frontiers in Signal Processing, 2 https://doi.org/10.3389/frsip.2022.826967
Alpert, Sharon, & Galun, Meirav, & Nadler, Boaz, & Basri, Ronen (2010). Detecting Faint Curved Edges in Noisy Images. European Conference on Computer Vision, 750-763, https://doi.org/10.1007/978-3-642-15561-1_54
Gupta, Abhishek, & Alagan, Anpalagan, & Guan, Ling, & Khwaja S., Ahmed (2021). Deep learning for object detection and scene perception in self-driving cars: Survey, challenges, and open issues. Array, 10, https://doi.org/10.1016/j.array.2021.100057
Cheng, Zhonghao, & Chai, Senchun (2019). An Image Orientation Estimation Method Based on Gradient Histogram and Point Matching. Chinese Automation Congress, 4896-49000, https://doi.org/10.1109/CAC48633.2019.8997224
Donoser, Michael, & Schmalsteig, Dieter (2014). Discrete-Continuous Gradient Orientation Estimation for Faster Image Segmentation. IEEE Conference on Computer Vision and Pattern Recognition, 3158-3165, https://doi.org/10.1109/CVPR.2014.404

What is claimed is:

1. Methodology for image gradient and derivative computation image processing, comprising:
obtaining a target digital image comprising a plurality of pixels; and
applying gradient detection to the pixel data of the target digital image, wherein said gradient detection comprises use of both a wide view filter and a line filter, and combining the output of the wide view filter and the line filter to indicate edges appearing in the target digital image.

2. The methodology according to claim 1, wherein use of the wide view filter and the line filter is conducted in one of parallel or sequential order.

3. The methodology according to claim 1, wherein each of the wide view filter and the line filter comprise respective gradient detection kernels based on two-dimensional high order Taylor Series expansions.

4. The methodology according to claim 1, wherein each of the wide view filter and the line filter respectively perform derivative calculations based on pixel values from the target digital image.

5. The methodology according to claim 3, wherein pixel values used by the gradient detection kernel of the wide view filter designate an indexed pixel in the target digital image and selects the Nₚ pixels closest to the indexed pixel.

6. The methodology according to claim 5, wherein derivatives are calculated for the wide view filter in a specific orientation.

7. The methodology according to claim 1, wherein:
the wide view filter comprises a gradient detection kernel based on two-dimensional high order Taylor Series expansions;
the wide view filter performs derivative calculations based on pixel values from the target digital image, designating an indexed pixel in the target digital image and selecting the Nₚ pixels closest to the indexed pixel; and
the line filter comprises a string of wide view filters.

8. The methodology according to claim 7, wherein the line filter uses a high order Taylor expansion to compute all the derivatives along both normal and tangential directions at a target pixel.

9. The methodology according to claim 8, wherein the line filter determines numerical derivatives at the target pixel using weighted derivative values of multiple pixels along the line filter oriented in a specific direction.

10. The methodology according to claim 4, further comprising:
using one of the wide view filter or the line filter to calculate derivative maps of the derivative values of each pixel at a plurality of selected orientation angles;
performing angle detection by parsing through each pixel using a numerical interpolation approach and then producing a histogram of the frequency of all the angles calculated for each pixel in the image; and
clustering all the angles to match determined edges in the image.

11. A system for image gradient and derivative computation image processing, comprising:
a target digital image comprising a plurality of pixels; and
one or more processors programmed for
applying gradient detection to the pixel data of the target digital image, wherein said gradient detection comprises use of both a wide view filter and a line filter, and
combining the output of the wide view filter and the line filter to indicate edges appearing in the target digital image.

12. The system according to claim 11, wherein said one or more processors are further programmed for use of the wide view filter and the line filter conducted in one of parallel or sequential order.

13. The system according to claim 11, wherein said one or more processors are further programmed for each of the wide view filter and the line filter comprising respective gradient detection kernels based on two-dimensional high order Taylor Series expansions.

14. The system according to claim 11, wherein said one or more processors are further programmed for each of the wide view filter and the line filter respectively performing derivative calculations based on pixel values from the target digital image.

15. The system according to claim 13, wherein pixel values used by the gradient detection kernel of the wide view filter designate an indexed pixel in the target digital image and selects the Nₚ pixels closest to the indexed pixel.

16. The system according to claim 15, wherein said one or more processors are further programmed so that derivatives are calculated for the wide view filter in a specific orientation.

17. The system according to claim 11, wherein said one or more processors are further programmed for:
the wide view filter comprising a gradient detection kernel based on two-dimensional high order Taylor Series expansions;
the wide view filter performing derivative calculations based on pixel values from the target digital image, designating an indexed pixel in the target digital image, and selecting the Nₚ pixels closest to the indexed pixel; and
the line filter comprising a string of wide view filters.

18. The system according to claim 17, wherein said one or more processors are further programmed for the line filter using a high order Taylor expansion to compute all the derivatives along both normal and tangential directions at a target pixel.

19. The system according to claim 18, wherein said one or more processors are further programmed for the line filter determining numerical derivatives at the target pixel using weighted derivative values of multiple pixels along the line filter oriented in a specific direction.

20. The system according to claim 14, wherein said one or more processors are further programmed for:
using one of the wide view filter or the line filter to calculate derivative maps of the derivative values of each pixel at a plurality of selected orientation angles;
performing angle detection by parsing through each pixel using a numerical interpolation approach and then producing a histogram of the frequency of all the angles calculated for each pixel in the image; and
clustering all the angles to match determined edges in the image.

21. Methodology for image gradient and derivative computation image processing, comprising:
obtaining a target digital image comprising a plurality of pixels;
using both a wide view filter and a line filter for respectively applying gradient detection to the pixel data of the target digital image to respectively perform derivative calculations based on pixel values;
using one of the wide view filter or the line filter to calculate derivative maps of the derivative values of each pixel from the target digital image at a plurality of selected orientation angles;
combining the output of the wide view filter and the line filter to indicate edges appearing in the target digital image;
performing angle detection by parsing through each pixel using a numerical interpolation approach and then producing a histogram of the frequency of all the angles calculated for each pixel in the image; and
clustering all the angles to match determined edges in the image.

22. The methodology according to claim 21, wherein use of the wide view filter and the line filter is conducted in one of parallel or sequential order.

23. The methodology according to claim 21, wherein:
pixel values used by the wide view filter comprise designating an indexed pixel in the target digital image and selecting the Nₚ pixels closest to the indexed pixel; and
the line filter comprises a string of wide view filters.

24. The methodology according to claim 23, wherein:
the line filter uses a high order Taylor expansion to compute all the derivatives along both normal and tangential directions at a target pixel; and
the line filter determines numerical derivatives at the target pixel using weighted derivative values of multiple pixels along the line filter oriented in a specific direction.
